(19) United States
(12) Patent Application Publication
(10) Pub. No.: US 2023/0290936 A1
(43) Pub. Date: Sep. 14, 2023

(54) ELECTROLYTE FORMULATIONS AND ADDITIVES FOR IRON ANODE ELECTROCHEMICAL SYSTEMS

(71) Applicant: FORM ENERGY, INC., Somerville, MA (US)

(72) Inventors: Annelise Christine THOMPSON, Medford, MA (US); Michael Andrew GIBSON, Philadelphia, MA (US); William Henry WOODFORD, Cambridge, MA (US); Rebecca Marie EISENACH, Somerville, MA (US); Jocelyn Marie NEWHOUSE, Somerville, MA (US); Nicholas Reed PERKINS, Somerville, MA (US); Olivia Claire TAYLOR, Somerville, MA (US); Kjell William SCHRODER, Medford, MA (US); Karen THOMAS-ALYEA, Arlington, MA (US); Zachariah NORMAN, Lincoln, MA (US); Johanna GOODMAN, Lincoln, MA (US); Jonathan Thomas VARDNER, Somerville, MA (US); Benjamin Thomas HULTMAN, Somerville, MA (US); Sydney GARY, Medford, MA (US); Natalie MAKO, Cambridge, MA (US); Renee MITCHELL, Somerville, MA (US); Brooke WOJESKI, Cambridge, MA (US); Jarrod David MILSHTEIN, Cambridge, MA (US)

(21) Appl. No.: 18/050,322

(22) Filed: Oct. 27, 2022

Related U.S. Application Data
(63) Continuation-in-part of application No. 17/661,256, filed on Apr. 28, 2022.
(60) Provisional application No. 63/181,757, filed on Apr. 29, 2021.

(51) Int. Cl. H01M 4/38; H01M 10/26; H01M 10/44

(52) U.S. Cl. CPC H01M 4/38; H01M 10/26; H01M 10/44; H01M 2300/0014

(57) ABSTRACT

Systems, methods, and devices of various aspects include using tin, antimony, and/or indium as an additive to an electrolyte and/or electrode in an electrochemical system, such as a battery, having an iron-based anode. In some aspects, the addition of tin, antimony, and/or indium may improve cycling of the iron-based anode. Systems, methods, and devices of various aspects include using high hydroxide concentration electrolyte in an electrochemical system, such as a battery. In some aspects, a high hydroxide concentration electrolyte may increase the stored amount of charge stored in the cell (i.e., the capacity of the battery material) and/or decrease the overpotential (i.e., increase the voltage) of the battery.

### RELATED APPLICATIONS

This application is a continuation-in-part of, and claims priority to, pending U.S. Non-Provisional application Ser. No. 17/661,256 filed Apr. 28, 2022 entitled “ELECTROLYTE FORMULATIONS AND ADDITIVES FOR IRON ANODE ELECTROCHEMICAL SYSTEMS” which claims the benefit of priority to U.S. Provisional Patent Application No. 63/181,757 entitled “ELECTROLYTE FORMULATIONS AND ADDITIVES FOR IRON ANODE ELECTROCHEMICAL SYSTEMS” filed Apr. 29, 2021, the entire contents of both of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

Iron-based negative electrode electrochemical systems (or said another way iron-based anode electrochemical systems) are attractive options for electrochemical energy storage. However, it can be difficult to achieve high performance in iron-based negative electrodes, especially at lower discharge rates, such as discharge rates associated with full discharge times of greater than about 8 hours, such as 8 hours, more than 8 hours, 8-16 hours, 16 hours, more than 16 hours, 16-24 hours, 24 hours, more than 24 hours, 24-30 hours, 30 hours, more than 30 hours, etc. Direct reduced iron (“DRI”) is an excellent candidate for an iron-based negative electrode due to DRI's costs, but electrodes fabricated from DRI can face challenges in realizing performance increases, despite promising material properties of DRI.

Iron-based alkaline electrochemical systems are attractive options for long duration energy storage at grid scale due to the low entitlement cost of iron and alkaline electrolyte components. However, iron-based materials suffer from several drawbacks in alkaline electrolytes, especially competition with the hydrogen evolution reaction and self-discharge. Further, grid scale energy storage requires the use of raw materials which are lower cost, and thus can be of lower purity, than traditional iron electrode materials. As a result, it can be difficult to cycle the iron electrode materials, and especially a metallic iron-iron hydroxide reaction (step 1 reaction). In most iron electrode systems, this step 1 reaction can be critical for enabling high round trip efficiency of the battery.

Thus, there exists a need to improve the design and composition of electrochemical systems having iron-based materials, such as iron-based negative electrodes, to enhance the performance of such systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems, methods, and devices of various aspects include using tin, antimony, and/or indium as an additive to an electrolyte and/or electrode in an electrochemical system, such as a battery, having an iron-based anode. In some aspects, the addition of tin, antimony, and/or indium may improve cycling of the iron-based anode.

Embodiments may include a battery, comprising: a first electrode, comprising direct reduced iron (DRI) or another sponge iron powder; an electrolyte; and a second electrode, wherein the first electrode or the electrolyte includes an additive containing an element that has a low hydrogen evolution reaction (HER) activity and/or improves a characteristic of the battery. In some embodiments, the element comprises tin, antimony, and/or indium. In various embodiments, improving a characteristic of the battery may include one or more of: improving charging of the first electrode; improving a conditioning process of the first electrode; improving reversibility of a half-cell reaction of the first electrode; and improving discharge capacity of the first electrode.

Systems, methods, and devices of various aspects include using high hydroxide concentration electrolyte in an electrochemical system, such as a battery. In some aspects, a high hydroxide concentration electrolyte may increase the stored amount of charge stored in the cell (i.e., the capacity of the battery material) and/or decrease the overpotential (i.e., increase the voltage) of the battery.

Embodiments may include a battery, comprising: a first electrode, comprising direct reduced iron (DRI) or another sponge iron powder; an electrolyte comprising a hydroxide; and a second electrode, wherein the electrolyte further comprises an additive, said additive comprising at least one of tin, lead, or antimony. In some embodiments, a total hydroxide concentration in the electrolyte may be about 6 M or greater.

Various embodiments may include alkyl polyglucosides used as a co-additive with metallic HER inhibitors. Various embodiments may include incorporation of tin into a current collector. Various embodiments may include tin incorporation into sponge irons. Various embodiments may include hydrogen oxidation catalysts and/or hydrogen getters as additives to an anode of an electrochemical cell. Various embodiments may include lignosulfonate used as an electrolyte additive and/or an anion selective membranes.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a schematic of an electrochemical cell, according to various embodiments of the present disclosure.

FIGS. 2A-2C are tin pourbaix diagrams.

FIG. 3 is an antimony pourbaix diagram.

FIG. 4 shows graphs of experimental results for different DRI types using different hydroxide concentrations according to various embodiments.

FIG. 5 is a solubility diagram for KOH vs temperature.

FIG. 6 is a phase diagram of a K₂Sn(OH)₆—KOH—H₂O system at 25.0° C.

FIG. 7 illustrates aspects of an electrochemical cell including a lignosulfonate membrane in accordance with various embodiments.

FIGS. 8-16 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” and the symbol “—” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

As used herein, unless specified otherwise the terms %, weight % (abbreviated wt %), and mass % are used interchangeably and refer to the weight of a first component as a percentage of the weight of the total, e.g., formulation, mixture, particle, pellet, agglomerate, material, structure or product. As used herein, unless specified otherwise “volume %” and “% volume” and similar such terms refer to the volume of a first component as a percentage of the volume of the total, e.g., formulation, mixture, particle, pellet, agglomerate, material, structure or product.

As used herein, unless specified otherwise the term “molar”, abbreviated “M” is used to refer to molar concentration, also called molarity, defined as the number of moles per liter (mol/L) of a substance in a solution. As an example, a substance at a concentration of 1 mol/L in a solution is referred to herein as being 1 M or at a concentration of 1 M. Similarly, a millimolar (mM) is used herein to mean one thousandth of a mole per liter.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

As used herein, unless specified otherwise, the terms specific gravity, which is also called apparent density, should be given their broadest possible meanings, and generally mean weight per unit volume of a structure, e.g., volumetric shape of material. This property would include internal porosity of a particle as part of its volume. It can be measured with a low viscosity fluid that wets the particle surface, among other techniques.

As used herein, unless specified otherwise, the terms actual density, which may also be called true density, should be given their broadest possible meanings, and general mean weight per unit volume of a material, when there are no voids present in that material. This measurement and property essentially eliminates any internal porosity from the material, e.g., it does not include any voids in the material.

Thus, a collection of porous foam balls (e.g., Nerf® balls) can be used to illustrate the relationship between the three density properties. The weight of the balls filling a container would be the bulk density for the balls:

$$Bulk Density = \frac{weight of balls}{volume of container filled}$$

The weight of a single ball per the ball's spherical volume would be its apparent density:

$$Apparent Density = \frac{weight of one ball}{volume of that ball}$$

The weight of the material making up the skeleton of the ball, i.e., the ball with all void volume removed, per the remaining volume of that material would be the skeletal density:

$$Skeletal Density = \frac{weight of material}{volume of void free material}$$

As used herein, unless specified otherwise, the term agglomerate and aggregate should be given their broadest possible meanings, and in general mean assemblages of particles in a powder.

The following examples are provided to illustrate various embodiments of the present systems and methods of the present inventions. These examples are for illustrative purposes, may be prophetic, and should not be viewed as limiting, and do not otherwise limit the scope of the present inventions.

Various embodiments are discussed in relation to the use of direct reduced iron (DRI) as a material in a battery (or cell), as a component of a battery (or cell) and combinations and variations of these. In various embodiments, the DRI may be produced from, or may be, material which is obtained from the reduction of natural or processed iron ores, without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal)(Fe⁰, wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India.

Although the term “sponge iron” is used in the specific context of direct reduction for the steelmaking industry, sponge irons are a broader class of iron-based materials. Sponge irons may be any material formed through the solid-state reduction of iron resulting in an iron-based structure that has more porosity than prior to reduction. Sponge irons need not be made from ore. Rather, sponge irons may be produced from any Fe—O species that may be reduced to form a porous structure. Such feedstocks may include mill scales, acid-digested and purified feedstocks, and sinter feed, ore, processed ore, or any other suitable Fe—O species for reduction to form a structure with increased porosity.

Embodiments of iron materials, including for example embodiments of DRI materials, for use in various embodiments described herein, including as electrode materials, may have, one, more than one, or all of the material properties as described in Table 1 below. As used in the Specification, including Table 1, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass. Weight and volume percentages and apparent densities as used herein are understood to exclude any electrolyte that has infiltrated porosity or fugitive additives within porosity unless otherwise stated.

TABLE 1

| Material Property | Embodiment Range |
|---|---|
| Specific surface area* | 0.01-25 m²/g |
| Actual density** | 4.6-7.1 g/cc |
| Apparent density*** | 2.3-6.5 g/cc |
| Minimum d_{pore, 90% volume}**** | 10 nm-50 μm |
| Minimum d_{pore, 50% surface area}***** | 1 nm-15 μm |
| Total Fe (wt %)^{#} | 65-100% |
| Metallic Fe (wt %)^{##} | 46-100% |
| Metallization (%)^{###} | 59-100% |
| Carbon (wt %)^{####} | 0-5% |
| Fe²⁺ (wt %)^{######} | 1-9% |
| Fe³⁺ (wt %)^{$} | 0-25% |
| SiO₂ (wt %)^{$$} | 0-15% |
| Ferrite (wt %, XRD)^{$$$} | 22-97% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | <<80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. dpore, 50% surface area is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %). Specifically, the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) - Metallic Fe (wt %) - Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂
wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$}Goethite (FeOOH, wt %, XRD) preferably determined by x-ray diffraction (XRD).
⁺Cementite (Fe₃C, wt %, XRD) preferably determined by x-ray diffraction (XRD).

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 1A.

TABLE 1A

| | | | | |
|---|---|---|---|---|
| Fe total (wt %)^{!} | >60% | >70% | >80% | ~83-94% |
| SiO₂ (wt %)^{!!} | <12% | <7.5% | 1-10% | 1.5-7.5% |
| Al₂O₃ (wt %)^{!!!} | <10% | <5% | 0.2-5% | 0.3-3% |
| MgO (wt %)^{!!!!} | <10% | <5% | 0.1-10% | 0.25-2% |
| CaO (wt %)^{!!!!!} | <10% | <5% | 0.9-10% | 0.75-2.5% |
| TiO₂ (wt %)^{&} | <10% | <2.5% | 0.05-5% | 0.25-1.5% |
| Size (largest cross- | <200 mm | ~50 to ~150 mm | ~2 to ~30 mm | ~4 to ~20 mm |
| sectional distance, | | | | |
| e.g. for a sphere the | | | | |
| diameter) | | | | |
| Actual Density | ~5 | ~5.8 to ~6.2 | ~4.0 to ~6.5 | <7.8 |
| (g/cm³)^{&&} | | | | |
| Apparent | <7.8 | >5 | >4 | 3.4~3.6 |
| Density | | | | |
| (g/cm³)^{&&&} | | | | |
| Bulk Density | <7 | >1.5 | ~2.4 to ~3.4 | ~1.5 to ~2.0 |
| (kg/m³)^{&&&&} | | | | |
| Porosity | >15% | >50% | ~ 20% to ~90% | ~50% to ~70% |
| (%)^{&&&&&} | | | | |

^{!}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{!!}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{!!!}Al₂O₃ (wt %) preferably determined by flame atomic absorption spectrometric method, and more preferably as is set forth in ISO 4688-1 (the entire disclosure of which is incorporated herein by reference); recognizing that other tests, such as x-ray diffraction (XRD), may be employed to provide results that can be correlated with flame atomic absorption spectrometric method. In certain methods, the Al₂O₃ wt % is not determined directly, but rather the Al concentration (inclusive of neutral and ionic species) is measured, and the Al₂O₃ wt % is calculated assuming the stoichiometry of Al₂O₃; that is, a 2:3 molar ratio of Al:O is assumed.
^{!!!!}MgO (wt %) preferably determined by flame atomic absorption spectrometric method, and more preferably as is set forth in ISO 10204 (the entire disclosure of which is incorporated herein by reference); recognizing that other tests, such as x-ray diffraction (XRD), may be employed to provide results that can be correlated with flame atomic absorption spectrometric method. In certain methods, the MgO wt % is not determined directly, but rather the Mg concentration (inclusive of neutral and ionic species) is measured, and the MgO wt % is calculated assuming the stoichiometry of MgO; that is, a 1:1 molar ratio of Mg:O is assumed.
^{!!!!!}CaO (wt %) preferably determined by flame atomic absorption spectrometric method, and more preferably as is set forth in ISO 10203 (the entire disclosure of which is incorporated herein by reference); recognizing that other tests, such as x-ray diffraction (XRD), may be employed to provide results that can be correlated with flame atomic absorption spectrometric method. In certain methods, the CaO wt % is not determined directly, but rather the Ca concentration (inclusive of neutral and ionic species) is measured, and the CaO wt % is calculated assuming the stoichiometry of CaO; that is, a 1:1 molar ratio of Ca:O is assumed.
^{&}TiO₂ (wt %) preferably determined by a diantipyrylmethane spectrophotometric method, and more preferably as is set forth in ISO 4691 (the entire disclosure of which is incorporated herein by reference); recognizing that other tests, such as x-ray diffraction (XRD), may be employed to provide results that can be correlated with the diantipyrylmethane spectrophotometric method It. In certain methods, the TiO₂ wt % is not determined directly, but rather the Ti concentration (inclusive of neutral and ionic species) is measured, and the TiO₂ wt % is calculated assuming the stoichiometry of TiO₂; that is, a 1:2 molar ratio of Ti:O is assumed.
^{&&}Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
^{&&&}Apparent density preferably determined by immersion in water, and more preferably as is set forth in ISO 15968 (the entire disclosure of which is incorporated herein by reference); recognizing that other tests may be employed to provide results that can be correlated with He pycnometry results.
^{&&&&}Bulk Density (kg/m³) preferably determined by measuring the mass of a test portion introduced into a container of known volume until its surface is level, and more preferably as is set forth in Method 2 of ISO 3852 (the entire disclosure of which is incorporated herein by reference); recognizing that other tests may be employed to provide results that can be correlated with the massing method.
^{&&&&&}Porosity determined preferably by the ratio of the apparent density to the actual density:
$Porosity = \frac{apparent density}{actual density}$

The properties set forth in Table 1, may also be present in embodiments with, in addition to, or instead of the properties in Table 1A. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. Iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 2 below. The use of reduced BF grade DRI may be advantageous due to the lesser input energy required to produce the pellet, which translates to a lower cost of the finished material.

TABLE 2

| Material Property | Embodiment Range |
|---|---|
| Specific surface area* | 0.21-25 m2/g |
| Actual density ** | 5.5-6.7 g/cc |
| Apparent density*** | 3.1-4.8 g/cc |
| Minimum d_{pore, 90% volume}**** | 50 nm-50 μm |
| Minimum d_{pore, 50% surface area}***** | 1 nm-10 μm |
| Total Fe (wt %)^{#} | 81.8-89.2% |
| Metallic Fe (wt %)^{##} | 68.7-83.2% |
| Metallization (%)^{###} | 84-95% |
| Carbon (wt %)^{####} | 0.03-0.35% |
| Fe²⁺ (wt %)^{#####} | 2-8.7% |
| Fe³⁺ (wt %)^{$} | 0.9-5.2% |
| SiO₂ (wt %)^{$$} | 3-7% |
| Ferrite (wt %, XRD)^{$$$} | 80-96% |
| Wustite (FeO, wt %, XRD)^{$$$$} | 2-13% |
| Goethite (FeOOH, wt %, XRD)^{$$$$$} | 0-11% |
| Cementite (Fe₃C, wt %, XRD)⁺ | 0-80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. dpore, 50% surface area is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
Fe³⁺ (wt %) preferably determined by the mass balance relation between and among Total Fe (wt %), Metallic Fe (wt %), Fe²⁺ (wt %) and Fe³⁺ (wt %). Specifically, the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) − Metallic Fe (wt %) − Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).
The properties set forth in Table 2, may also be present in embodiments with, in addition to, or instead of the properties in Tables 1 and/or 1A. Greater and lesser values for these properties may also be present in various embodiments.

In certain embodiments the DRI may be produced by the reduction of a DR Grade pellet, in which case the resulting DRI may have material properties as described in Table 3 below. The use of reduced DR grade DRI may be advantageous due to the higher Fe content in the pellet which increases the energy density of the battery.

TABLE 3

| Material Property | Embodiment Range |
|---|---|
| Specific surface area* | 0.1-0.7 m²/g as received or |
| | 0.19-25 m²/g after performing |
| | a pre-charge formation step |
| Actual density** | 4.6-7.1 g/cc |
| Apparent density*** | 2.3-5.7 g/cc |
| Minimum d_{pore, 90% volume}**** | 50 nm-50 um |
| Minimum d_{pore, 50% surface area}***** | 1 nm-10 um |
| Total Fe (wt %)^{#} | 80-94% |
| Metallic Fe (wt %)^{##} | 64-94% |
| Metallization (%)^{###} | 80-100% |
| Carbon (wt %)^{####} | 0-5% |
| Fe²⁺ (wt %)^{#####} | 0-8% |
| Fe³⁺ (wt %)^{$} | 0-10% |
| SiO₂ (wt %)^{$$} | 1-4% |
| Ferrite (wt %, XRD)^{$$$} | 22-80% |
| Wustite (Fe), wt %, XRD)^{$$$$} | 0-13% |
| Goethite (FeOOH, wt %, XRD)^{$$$$$} | 0-23% |
| Cementite (Fe₃C, wt %, XRD)⁺ | <<80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = \frac{apparent density}{actual density}$ ****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.
*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 50% surface area} is the pore diameter above which 50% of free surface area exists.
^{#}Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.
^{##}Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.
^{###}Metallization (%) preferably determined by the ratio of metallic Fe to total Fe, each as preferably determined by the methods previously described.
^{####}Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.
^{#####}Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.
^{$}Fe³⁺ (wt %) preferably determined by the mass balance relation between and among Total Fe (wt %), Metallic Fe (wt %), Fe²⁺ (wt %) and Fe³⁺ (wt %). Specifically, the equality Total Fe (wt %) = Metallic Fe (wt %) + Fe²⁺ (wt %) + Fe³⁺ (wt %) must be true by conservation of mass, so Fe³⁺ (wt %) may be calculated as Fe³⁺ (wt %) = Total Fe (wt %) − Metallic Fe (wt %) - Fe²⁺ (wt %).
^{$$}SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂
wt % is calculated assuming the stoichiometry of SiO₂; that is, a 1:2 molar ratio of Si:O is assumed.
^{$$$}Ferrite (wt %, XRD) preferably determined by x-ray diffraction (XRD).
^{$$$$}Wustite (FeO, wt %, XRD) preferably determined by x-ray diffraction (XRD).
^{$$$$$}Goethite (FeOOH, wt %, XRD) preferably determined by x-ray diffraction (XRD).
⁺Cementite (Fe₃C, wt %, XRD) preferably determined by x-ray diffraction (XRD).

The properties set forth in Table 3, may also be present in embodiments with, in addition to, or instead of the properties in Tables 1, 1A, and/or 2. Greater and lesser values for these properties may also be present in various embodiments.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when the sunshine is plentiful and solar power generation exceeds power grid requirements, and discharge the stored energy during the winter months, when the sunshine may be insufficient to satisfy power grid requirements.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

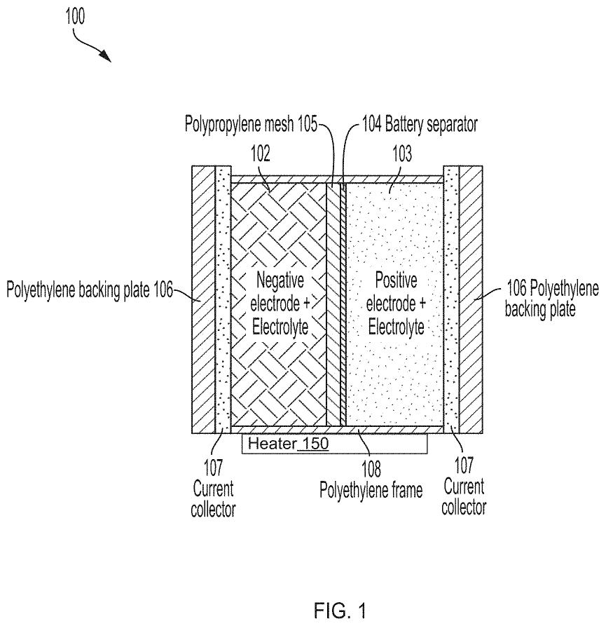

In some embodiments, an electrochemical cell includes a negative electrode, a positive electrode, an electrolyte, and a separator disposed between the positive electrode and the negative electrode (for example as shown in FIG. 1). FIG. 1 illustrates an example electrochemical cell 100, such as a battery, including a negative electrode and electrolyte 102 separated from a positive electrode and electrolyte 103 by a separator 104. The separator 104 may be supported by a polypropylene mesh 105 and a polyethylene frame 108 of the cell 100. Current collectors 107 may be associated with respective ones of the negative electrode 102 and positive electrode 103 and supported by polyethylene backing plates 106. In some embodiments, the temperature of the electrochemical cell 100, may be controlled, such as by insulation around the cell 100 and/or a heater 150. For example, the heater 150 may raise the temperature of the cell 100 and/or specific components of the cell, such as the electrolyte 102, 103. The configuration of the electrochemical cell 100 in FIG. 1 is merely an example of one electrochemical cell configuration according to various embodiments and is not intended to be limiting. Other configurations, such as electrochemical cells with different type meshes and/or without the polypropylene mesh 105, electrochemical cells with different type frames and/or without the polyethylene frame 108, electrochemical cells with different type current collectors and/or without the current collectors, electrochemical cells with different type backing plates and/or without the polyethylene backing plates 106, electrochemical cells with different type insulation and/or without insulation, and/or electrochemical cells with different type heaters and/or without a heater 150, may be substituted for the example configuration of the electrochemical cell 100 shown in FIG. 1 and other configurations are in accordance with the various embodiments.

In some embodiments, a plurality of electrochemical cells 100 in FIG. 1 may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

According to various embodiments, the negative electrode is comprised of pelletized, briquetted, pressed or sintered iron-bearing compounds. Such iron-bearing compounds may comprise one or more forms of iron, ranging from highly reduced (more metallic) iron to highly oxidized (more ionic) iron. In various embodiments, the pellets may include various iron compounds, such as iron oxides, hydroxides, sulfides, carbides, or combinations thereof. In various embodiments, said negative electrode may be sintered iron agglomerates with various shapes. In some embodiments, atomized or sponge iron powders can be used as the feedstock material for forming sintered iron electrodes. In some embodiments, the green body may further contain a binder such as a polymer or inorganic clay-like material. In various embodiments, sintered iron agglomerate pellets may be formed in a furnace, such as a continuous feed calcining furnace, batch feed calcining furnace, shaft furnace, rotary calciner, rotary hearth, etc. In various embodiments, pellets may comprise forms of reduced and/or sintered iron-bearing precursors known to those skilled in the art as direct reduced iron (DRI), and/or its byproduct materials. Various embodiments may include processing pellets, including DRI pellets, using electrical, electrochemical, mechanical, chemical, and/or thermal processes before introducing the pellets into the electrochemical cell.

According to various embodiments, an electrochemical cell, such as cell 100 of FIG. 1, includes a negative electrode (also referred to as an anode), a positive electrode (also referred to as a cathode), and an electrolyte. The negative electrode may be an iron material. The electrolyte may be an aqueous solution. In certain embodiments the electrolyte may be an alkaline solution (pH>10). In certain embodiments, the electrolyte may be a near-neutral solution (10>pH>4).

In one example, half-cell reactions on the negative electrode as occurring on discharge and oxidation in the alkaline electrolyte are: step 1) Fe+2OH⁻⇄Fe(OH)₂+2e⁻; and step 2) 3Fe(OH)₂+2OH⁻⇄Fe₃O₄+4H₂O+2e⁻. In a step 1 (also referred to herein as “step 1 reaction” or “reaction step 1”), iron hydroxide may be formed on the surface of the iron forming the negative electrode. In step 2 (also referred to herein as “step 2 reaction” or “reaction step 2”), the iron hydroxide is subsequently oxidized further to form magnetite. There is a net volume increase upon discharge that is taken up in the porosity of the negative electrode. The theoretical capacity on the basis of metallic iron according to the negative electrode reactions in this example is 960 mAh/gFe in step 1, 320 mAh/gFe in step 2.

Iron-based electrodes (also referred to as Fe anodes) are difficult to recharge due to competition with hydrogen (H₂) evolution, a side-reaction that does not lead to recharging of the battery, because electrons are diverted to H₂ rather than stored in a more reduced iron-bearing negative electrode. Additionally, the ability of electrons to move through the anode may also hinder the charge and discharge reactions. When there is no, or a limited, pathway to move electrons through the anode, the efficiency of charge and discharge of the anode may decrease. Another issue that can hinder recharging in iron-based electrodes is pore clogging. In some cases, methods to increase surface area of the iron-based anodes can also lead to pore clogging of the anode. When the pores of the anode clog, the ions cannot get in and out of the anode, and the anode cannot be recharged. Coupled with difficulty in recharging the Fe anode, this clogging leads to large losses in specific discharge capacity.

In various embodiments, one or more additives, such as lead (Pb), tin (Sn), antimony (Sb), copper (Cu), silver (Ag), gold (Au), etc. may be added to an electrochemical cell. The addition of one or more additives in accordance with various embodiments may improve charging of an iron-based negative electrode (Fe anode). In various embodiments, the one or more additives may include elements that in their metallic form have a low hydrogen evolution reaction (HER). In various embodiments, the electrochemical cell into which the one or more additives are added may include an electrolyte that includes one or more hydroxide. In various embodiments, the electrochemical cell into which the one or more additives are added may include an electrolyte that does not include hydroxides.

In various embodiments, additives that suppress hydrogen evolution, such as metals with low hydrogen evolution reaction (HER) activity (such as lead (Pb), tin (Sn), antimony (Sb), indium (In), etc.) may be added to an electrochemical cell to thereby improve charging of the iron-based negative electrode (Fe anode). In various embodiments, additives that suppress hydrogen evolution, such as metals with low hydrogen evolution reaction (HER) activity (such as lead (Pb), tin (Sn), antimony (Sb), indium (In), etc.) may be added to the electrolyte and/or anode of the electrochemical cell.

A low hydrogen evolution reaction (HER) activity additive may be defined relative to the HER activity of iron. In a first example, an additive that has a hydrogen evolution reaction (HER) exchange current density lower than that of iron may be considered a low hydrogen evolution reaction (HER) activity additive. In a second example, a cell comprising a low HER activity additive has a reduced rate of hydrogen evolution in the cell, (e.g., as measured through in situ sensing of hydrogen generation) compared to a cell not comprising the low HER activity additive. In a third example, a cell comprising a low HER activity additive produces less hydrogen at a given state of charge than a comparable cell not comprising the low HER activity additive. In one set of examples, significantly lower HER activity may be a 50% or greater reduction in HER activity. In a further set of examples, significantly lower hydrogen generation may be a 10% or greater reduction in HER activity.

A low HER activity additive may also be defined by the coulombic efficiency of the iron anode containing cell. A low HER activity additive would increase the coulombic efficiency of the cell from that of a cell containing the iron anode material alone. A significantly higher coulombic efficiency may be >5% higher than a cell containing the anode material alone. In various embodiments, a low HER activity additive may be added to an electrochemical cell in a solid form (e.g., metallic form) and/or in a liquid form.

In various embodiments, additives that improve the conductive network in the iron anode, such as highly conductive metals (tin (Sn), copper (Cu), indium (In), silver (Ag), gold (Au)) or derivatives thereof may be added to an electrochemical cell to thereby improve charging of the iron-based negative electrode (Fe anode). In various embodiments, additives that improve the conductive network in the iron, such as highly conductive metals (tin (Sn), copper (Cu), indium (In) silver (Ag), gold (Au)) or derivatives thereof, may be added to the electrolyte and/or anode of the electrochemical cell. A highly conductive metal may be a metal element that has an electrical resistivity below 125 nano ohm-metres (nΩ·m).

In various embodiments, additives that assist with retaining other additives in the electrode or electrolyte, such as lead (Pb), tin (Sn), antimony (Sb), indium (In), etc., may be added to an a electrochemical cell to thereby improve charging of the iron-based negative electrode (Fe anode). These additives may work to form soluble or slightly soluble complexes or solid compounds with other additives present in the cell. In various embodiments, metals that complex with other additives in solution (such as lead (Pb), tin (Sn), antimony (Sb), indium (In), or derivatives thereof) may be added to the electrolyte and/or the anode of the electrochemical cell.

In various embodiments, additives that improve the reversibility of Fe (II) to Fe (0) such as tin (Sn), may be added to an electrochemical cell to thereby improve charging of the iron-based negative electrode (Fe anode).

In various embodiments, additives that incorporate into the Fe anode or are present during the conditioning process may be added to an electrochemical cell to thereby improve charging of the iron-based negative electrode (Fe anode). Without being bound by a particular theory, the conditioning process is the steps by which the surface area and interconnectivity of the Fe anode surface evolves. This conditioning process may occur by performing exhaustive discharges through reaction steps 1 and 2 or reaction step 1 alone for a number of cycles before the cell reaches a nominal discharge capacity (>200 mAh/g, 200-250 mAh/g, >250 mAh/g, 250-300 mAh/g, >300 mAh/g, 300-350 mAh/g, >350 mAh/g, 350-400 mAh/g, >400 mAh/g, etc.). After this point, the anode can be reversibly cycled at high capacities and efficiencies as needed by the application. The presence and/or incorporation of additives, such as Sn, Sb, In, Cu, Ag, Au, into the anode allows for improved discharge capacity and efficiency. While reactions steps 1 and/or 2 are discussed in relation to the condition process, the conditioning may not be so limited and may not require reactions additional, and/or different, reactions than reaction steps 1 and/or 2. The charging of the iron-based negative electrode (Fe anode) achieved during the conditioning process with additives present may be impacted by various factors, such as additive concentration (e.g., stannate concentration, etc.), charge capacity, temperatures, and/or morphology/structure of the anode material.

The conditioning process may be defined relative to a target discharge capacity. In a first example, an additive may increase discharge capacity over the conditioning process to greater than 200 mAh/g. A good conditioning additive would increase the discharge capacity after conditioning compared to that of a cell containing the iron anode material alone. A significantly higher capacity may be ≥5% higher than a cell containing the anode material alone. In various embodiments, a conditioning additive may be added to an electrochemical cell in a solid form (e.g., metallic form) and/or in a liquid form.

The conditioning process may be defined relative to the number of cycles or time to reach a target discharge capacity. In a first example, an additive may decrease the time needed to reach a target discharge capacity. A good conditioning additive would decrease the number of cycles or time to reach a given discharge capacity compared to that of a cell containing the iron anode material alone. A significantly faster time may be ≥5% faster than a cell containing the anode material alone. A significantly faster time may be 5% fewer cycles than a cell containing the anode material alone. In various embodiments, a conditioning additive may be added to an electrochemical cell in a solid form (e.g., metallic form) and/or in a liquid form.

The conditioning process may be defined relative to the ratio of the discharge capacity from reaction step 1 to the discharge capacity from reaction step 2 (the reaction step 1/reaction step 2 ratio). In a first example, an additive may increase the reaction step 1/reaction step 2 ratio over the conditioning process. A good conditioning additive would increase the reaction step 1/reaction step 2 ratio compared to that of a cell containing the iron anode material alone. A significantly better reaction step 1/reaction step 2 ratio may be ≥5% larger than a cell containing the anode material alone. In various embodiments, a conditioning additive may be added to an electrochemical cell in a solid form (e.g., metallic form) and/or in a liquid form.

In various embodiments, tin can be used as a way to maintain cell performance for cells that have varying OH concentration (between 4 and 8M). Cells with higher tin concentrations show less sensitivity to total hydroxide concentration, specifically for reaction one fraction of capacity and voltaic efficiency.

In various embodiments, tin depassivates the surface of the Fe anode in an electrochemical cell.

In various embodiments, tin increases the discharge capacity of the Fe anode in an electrochemical cell.

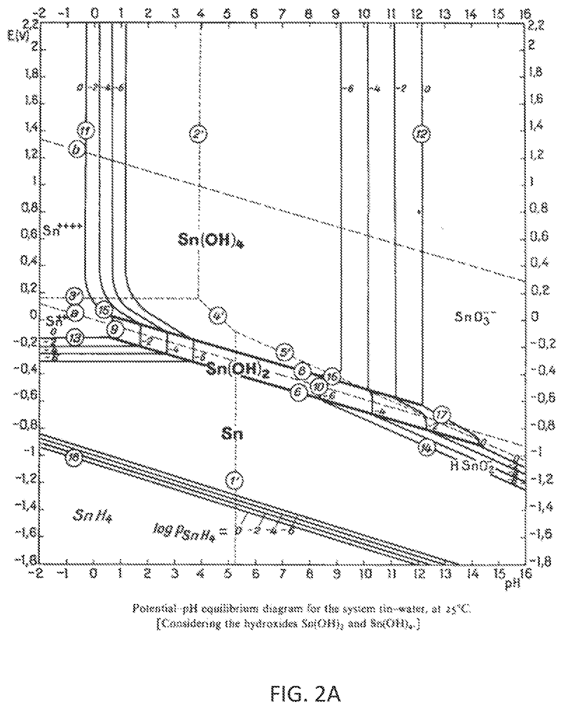

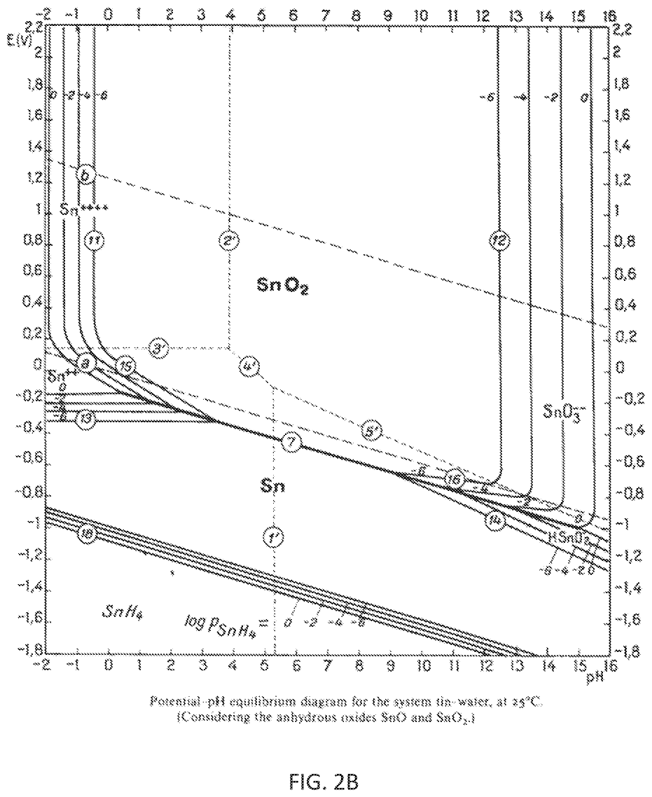

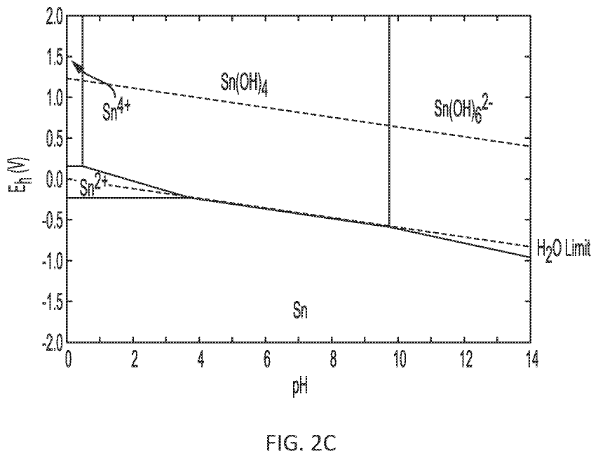

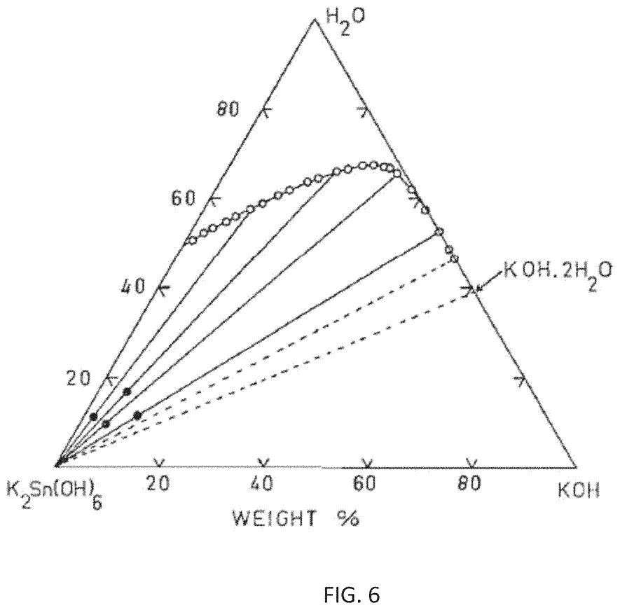

In various embodiments, tin (Sn) and/or tin-containing compounds may be included (e.g., added, present, etc.) in an electrochemical cell, such as in the electrolyte, as part of an electrode, as a reservoir in the electrochemical cell, etc. The inclusion of tin and/or tin containing compounds may decrease the propensity for hydrogen evolution at the iron anode, and thereby promote more effective recharging of the iron electrode; that is, upon recharging, more of the step 1 reaction capacity can be reversed, yielding more metallic iron in the charged state. In a subsequent discharge step, this results in a greater step 1 reaction capacity. Without being bound by any particular scientific interpretation or particular theory of operation, it is believed that the increase in hydrogen evolution overpotential may result from the deposition of tin on the iron anode as a metal, oxide, mixed Fe—Sn oxide, or Fe—Sn alloy, resulting in a HER activity reduction on the iron anode compared to the HER activity without the presence of tin. The reduction in HER activity may also result from an alloying, formation of a surface phase, electrodeposition of tin or tin derivatives, or complexation of tin with the iron anode material. Regardless of the mechanism of action, the noted benefit of cells comprising tin is an increase in charging efficiency for the iron anode in comparison to the charging efficiency without the presence of tin. Tin may be highly soluble in an alkaline solution (pH>10) electrolyte and the inclusion of tin and/or tin-containing compounds in electrolyte may result in the tin in the electrolyte plating the iron anode. For example, FIG. 6 is a phase diagram of a K₂Sn(OH)₆—KOH—H₂O system at 25.0° C. The solid circles in FIG. 6 represent the solution composition and the darkened circles represent the wet residue composition. As shown in FIG. 6, maximum solubility at 25.0° C. for 6 M of KOH is 0.272 M K₂Sn(OH)₆ and for 10-13 M OH is closer to 6 mM K₂Sn(OH)₆. The deposition of tin on the iron anode may increase the step 1 reaction capacity, i.e., Fe+2OH⁻⇄Fe(OH)₂+2e⁻ which may result from the formation of a new phase, FeSnOₓ, that may allow for better recharging of the iron anode. This inclusion of tin in the iron anode may also introduce a secondary high potential reaction, i.e., FeSn+n OH−⇄FeSnOx+m e−, improving total high potential discharge capacity due to a more efficient or altered charging mechanism. As examples, the inclusion of tin and/or tin containing compounds may improve the discharge potential of the iron anode to greater than 0.75V, greater than 0.8V, greater than 0.85V, greater than 0.9V, etc. The inclusion of tin and/or tin containing compounds may improve cycling of iron anodes in electrochemical cells. In various embodiments, the tin and/or tin containing compounds may include metallic tin, stannates, thiostannates, and/or any other source of tin. As specific examples, metallic tin (Sn), sodium stannate trihydrate (Na₂SnO₃·3H₂O), potassium stannate trihydrate (K₂SnO₃·3H₂O), calcium stannate (CaSnO3), magnesium stannate (MgSnO3), barium stannate (BaSnO3), cobalt stannate (Co2SnO4), tin oxide (SnO₂), cylindrite (Pb₃Sn₄FeSb₂S₁₄), canfieldite (Ag8SnS6), copper iron tin sulfide (Cu₂FeSnS₄), lead-tin alloys (60/40 Sn/Pb solder, 63/37 Sn/Pb solder, Terne I alloy: 10-20% Sn, balance Pb), zinc-tin alloys (Terne II alloy: 10-20% Sn, balance Zn), or tin sulfide (SnS or SnS₂) may be included in an electrochemical cell, such as in the electrolyte and/or in the electrode. In various embodiments, tin sources may be solid sources or tin and/or soluble sources of tin. FIGS. 2A-2C are pourbaix diagrams of tin.

In various embodiments, the tin and/or tin containing compounds may be included as part of the electrolyte in an electrochemical cell. As examples, the tin and/or tin containing compounds may be added to the electrolyte in amounts such that the added tin and/or tin containing compounds represent from about 0.1 millimolar (mM) to about the saturation limit of the tin and/or tin containing compounds in the electrolyte. As specific examples, the tin and/or tin containing compounds may be present in the electrolyte in a concentration of 0.1 mM, 0.1 mM to 10 mM, 0.1 mM to 100 mM (or 0.1 M), 10 mM, 10 mM to 100 mM (or 0.1 M), 10 mM to 50 mM, 50 mM, 50 mM to 60 mM, 10 mM to 70 mM, 10 mM to 60 mM, 50 mM to 100 mM (or 0.1 M), 50 mM to 70 mM, 60 mM to 70 mM, 60 mM, 70 mM, 70 mM to 100 mM (or 0.1M), 10 mM to 80 mM, 50 mM to 80 mM, 60 mM to 80 mM, 70 mM to 80 mM, 80 mM, 80 mM to 100 mM (or 0.1M), 100 mM (or 0.1 M), 100 mM (or 0.1 M) to 1 M, 1 M, 100 mM (or 0.1 M) to 750 mM (or 0.75 M), 750 mM (or 0.75 M), 100 mM (or 0.1 M) to 500 mM (or 0.5 M), 500 mM (or 0.5 M), 100 mM (or 0.1 M) to 600 mM (or 0.6 M), 600 mM (or 0.6 M), 100 mM (or 0.1 M) to 670 mM (or 0.67 M), 670 mM (or 0.67 M), 500 mM (or 0.5 M) to 670 mM (or 0.67 M), 600 mM (or 0.6 M) to 670 mM (or 0.67 M), 650 mM (or 0.65 M) to 670 mM (or 0.67 M), 650 mM (or 0.65 M), 0.1 mM to the saturation limit of the tin and/or tin containing compounds in the electrolyte, 10 mM to the saturation limit of the tin and/or tin containing compounds in the electrolyte, 50 mM to the saturation limit of the tin and/or tin containing compounds in the electrolyte, 100 mM (or 0.1 M) to the saturation limit of the tin and/or tin containing compounds in the electrolyte, 500 mM (or 0.5 M) to the saturation limit of the tin and/or tin containing compounds in the electrolyte, 600 mM (or 0.6 M) to the saturation limit of the tin and/or tin containing compounds in the electrolyte, 650 mM (or 0.65 M) to the saturation limit of the tin and/or tin containing compounds in the electrolyte, 650 mM (or 0.65 M) to the saturation limit of the tin and/or tin containing compounds in the electrolyte, 670 mM (or 0.67 M) to the saturation limit of the tin and/or tin containing compounds in the electrolyte, 750 mM (or 0.75 M) to the saturation limit of the tin and/or tin containing compounds in the electrolyte, below the saturation limit of the tin and/or tin containing compounds in the electrolyte, at the saturation limit of the tin and/or tin containing compounds in the electrolyte, etc. As further examples, the tin and/or tin containing compounds may be added to the electrolyte in amounts such that the added tin and/or tin containing compounds represent about 0.01 wt % to about 20 wt % of the electrolyte. As specific examples, the tin and/or tin containing compounds may be present in the electrolyte at 0.01 wt %, 0.01 wt % to 0.1 wt %, 0.1 wt %, 0.01 wt % to 5 wt %, 0.1 wt % to 5 wt %, 0.1 wt % to 20 wt %, 5 wt %, 5 wt % to 20 wt %, 20 wt %, etc.

In various embodiments, the tin and/or tin containing compounds may be included as part of the anode in an electrochemical cell. For example, the tin and/or tin containing compounds may be incorporated into the anode, such as mixed with the iron source for the anode, deposited on the surface of the anode, incorporated into a bed of the anode, etc. As examples, the tin and/or tin containing compounds may be added to the anode in amounts such that the added tin and/or tin containing compounds represent about 0.1 wt % to about 40 wt % of the anode based on the dry mass of the anode (no electrolyte included in the wt % figures). As specific examples, the tin and/or tin containing compounds may be present in the anode at 0.1 wt %, 0.1 wt % to 6 wt %, 0.1 wt % to 1 wt %, about 1 wt %, about 1 wt % to about 3 wt %, about 3 wt %, about 3 wt % to about 6 wt %, about 1 wt % to about 6 wt %, about 6 wt %, 6 wt % to 20 wt %, 0.1 wt % to 5 wt %, 0.1 wt % to 0.5 wt %, about 0.5 wt %, 0.5 wt % to 5 wt %, about 5 wt %, 5 wt % to 6 wt %, 5 wt % to 7 wt %, 6 wt % to 7 wt %, about 7 wt %, about 1 wt % to about 20 wt %, 20 wt %, about 20 wt %, about 7 wt % to about 20 wt %, about 20 wt % to about 35 wt %, about 35 wt %, about 1 wt % to about 35 wt %, about 7 wt % to about 35 wt %, 35 wt %, about 1 wt % to about 40 wt %, about 7 wt % to 40 wt %, about 20 wt % to about 40 wt %, about 35 wt % to about 40 wt %, about 40 wt %, 40 wt %, etc. Additionally, the tin and/or tin containing compounds may be added to the anode in amounts such that resulting tin incorporated into the anode relative to the active material weight of the anode (e.g., relative to the active iron material weight of the anode) is from about 0.044 wt % tin to about 20 wt % tin, such as about 0.044 wt % tin, 0.044 wt % tin to 0.1 wt % tin, about 0.1 wt % tin, 0.1 wt % tin to 6 wt % tin, 0.1 wt % tin to 1 wt % tin, about 1 wt % tin, about 1 wt % tin to about 3 wt % tin, about 3 wt % tin, about 3 wt % tin to about 6 wt % tin, about 1 wt % tin to about 6 wt % tin, about 6 wt % tin, 6 wt % tin to 20 wt % tin, 0.1 wt % tin to 5 wt % tin, about 5 wt % tin, 5 wt % tin to 6 wt % tin, 5 wt % tin to 7 wt % tin, 6 wt % tin to 7 wt % tin, about 7 wt % tin, 6 wt % tin to 10 wt % tin, about 10 wt % tin, 10 wt % tin to 20 wt % tin, about 20 wt % tin, etc.

In various embodiments, a stannate, such as sodium stannate trihydrate (Na₂SnO₃·3H₂O), potassium stannate trihydrate (K₂SnO₃·3H₂O), etc., may be added, or present, in an electrochemical cell. In various embodiments, a stannate, such as sodium stannate trihydrate (Na₂SnO₃·3H₂O), potassium stannate trihydrate (K₂SnO₃·3H₂O), etc., may be added, or present, in amounts of from about 0.1 wt % to about 35 wt % in the Fe anode or electrolyte of an electrochemical cell, such as a battery. As examples, a stannate, such as sodium stannate trihydrate (Na₂SnO₃·3H₂O), potassium stannate trihydrate (K₂SnO₃·3H₂O), etc., may be added, or present, in the Fe anode or electrolyte of an electrochemical cell, such as a battery, in amounts of about 0.1 wt %, about 0.1 wt % to about 15 wt %, about 15 wt %, about 15 wt % to about 20 wt %, about 20 wt %, about 20 wt % to about 35 wt %, about 35 wt %, etc.

In one experiment, 0.1 M sodium stannate (Na₂SnO₃·3H₂O) was dissolved in a 6 M potassium hydroxide-based electrolyte to provide a source of tin for incorporation into the anode. Specifically, after the sodium stannate was dissolved, the composition of the electrolyte with the sodium stannate added was 5.95 M KOH, 0.05 M LiOH, 0.007 M Na₂S, and 0.1 M Na₂SnO₃·3H₂O, and the experiment showed tin was incorporated into, adsorbed by, or found with the anode. The cell demonstrated increased total capacity, step 1 capacity, and increased voltaic efficiency, which leads to longer round-trip efficiency, over the entire course of cycling (20+ cycles). In various embodiments, as the electrolyte composition is adjusted, for example by the use of NaOH as part of the electrolyte in addition to or in place of KOH, similar molar concentrations may be used as those which result from the recited weight percent additions in potassium hydroxide-based electrolyte in order to achieve similar levels of performance. Other experiments have demonstrated that sulfide, such as Na₂S, may not need to be included in the electrolyte when sulfide may be included in the anode or electrochemical cell. In such an experiment, after the sodium stannate was dissolved, the composition of the electrolyte with the sodium stannate added and prior to contact with the anode or other electrodes was 5.95 M KOH, 0.05 M LiOH, and 0.04 M Na₂SnO₃·3H₂O.

In another experiment, 5 wt % sodium stannate (Na₂SnO₃·3H₂O), representing 2.22 wt % Sn to active iron material, was mixed with the iron source for the anode before testing. Specifically, after the sodium stannate was dissolved, the composition of the electrolyte with the sodium stannate added was 5.95 M KOH, 0.05 M LiOH, 0.01 M Na₂S, 5 wt % Na₂SnO₃·3H₂O and the experiment showed tin was incorporated into the anode, in addition to increased total and step 1 capacity.

In some embodiments, tin oxide (SNO₂) may be dissolved in the electrolyte at concentrations of 0.01 wt % to 20 wt. %. In some aspects, the SnO₂ source may be cassiterite ore. In some aspects, the SnO₂ source may be a refined and/or purified SnO₂ material relative to mined cassiterite ore.

In some embodiments, cylindrite (Pb₃Sn₄FeSb₂S₁₄) may be added to the electrolyte and/or electrode.

In some embodiments, copper iron tin sulfide (Cu₂FeSnS₄) may be added to the electrolyte and/or electrode.

In some embodiments, metallic tin may be added to the electrolyte and/or electrode.

In some embodiments, tin sulfide (SnS or SnS₂) may be added to the electrolyte and/or electrode.

In certain embodiments where the tin or tin-containing compound is a solid, the specific surface area of the solid (m²/g as measured by the Brunauer-Emmett-Teller method of gas adsorption) may be optimized to provide a specified level of reactivity such that there is a constant flux of tin into the liquid phase, or to maintain the tin concentration in the liquid electrolyte phase at or above a certain critical concentration.

In some embodiments, an electrolyte for use with an iron negative electrode may contain a tin-containing ion. The specific type or the tin-containing ion may vary based on the pH and the potential of the solution. In alkaline electrolytes, the tin ion may be SnO₃²⁻ or Sn(OH)₆²⁻. In some embodiments, the concentration of the tin-containing ion may be selected to be such that the dissolved tin in solution represents between 0.01 and 35 percent of the weight of active material iron in the negative electrode.

In various embodiments, tin and/or tin containing compounds may be included in the electrochemical cell in any suitable manner to result in tin being incorporated into the iron anode. As examples, the tin and/or tin containing compounds may be supplied into the electrochemical cells in any of the various manners discussed for placing additives in an electrochemical cell.

In some embodiments, the tin and/or tin containing compounds may be deposited on the anode and/or cathode of the electrochemical cell, such as by electroless deposition. In some embodiments, a tin reservoir may be provided in the electrochemical cell. The tin reservoir may allow for more tin to be added to the electrochemical cell than the solubility limit would otherwise allow. In some embodiments, the tin reservoir may be electrically connected to a source of oxidizing electrical potential to facilitate the dissolution of the tin due to formation of a tin-containing soluble ionic species. In some embodiments, the tin and/or tin containing compounds may be super saturated into the electrolyte. In some embodiments, the tin and/or tin containing compounds may be disposed as a foil, rod, or other form factor in the electrolyte and may dissolve into the electrolyte over time. In certain embodiments, an electrode held at a more positive (more anodic) potential may be initially tin-coated. As one non-limiting example, in an iron-air battery, a positive air electrode may be initially tin-coated, such that tin species are galvanically driven off the positive electrode and into solution. In certain embodiments, this air electrode may be an oxygen evolution reaction (OER) electrode. Tin (or tin-bearing) coatings could be, for example, applied by processes known to those skilled in the art as “hot dip,” or otherwise. When that tin coated electrode is initially polarized to an anodic potential, while in contact with an alkaline electrolyte, the tin species may dissolve into solution electrochemically and form stannate in the electrolyte. In various embodiments, the tin-coating can be applied on any portion of the oxidizing surfaces. In some embodiments, there may be a block or other shaped structure of tin electrically and mechanically connected to the OER electrode and/or oxygen reduction reaction (ORR) electrode and the block or other shaped structure of tin may corrode away thereby adding tin to the electrolyte. In some embodiments, a tin wire or rod may be mechanically isolated but electrically shorted to the second electrode during charge to dissolve the tin in an electrochemical cell. In some embodiments, a tin wire or rod may be mechanically and electrically connected to the second electrode during charge to dissolve the tin in an electrochemical cell. In some embodiments, a tin wire or rod may be mechanically and electrically isolated from all electrode, and be permitted to dissolve into the electrolyte over time.

In various embodiments, as the electrochemical cell is operated, tin and/or tin containing compounds may be added to the electrochemical cell. For example, tin and/or tin containing compound inserts may be replaced in the electrochemical cell, additional tin and/or tin containing compounds may be pumped into and/or otherwise added to the electrochemical cell, and/or tin and/or tin containing compounds may be added in other manners so as to maintain a selected molar amount and/or wt % of tin and/or tin containing compounds in the electrolyte and/or electrodes.

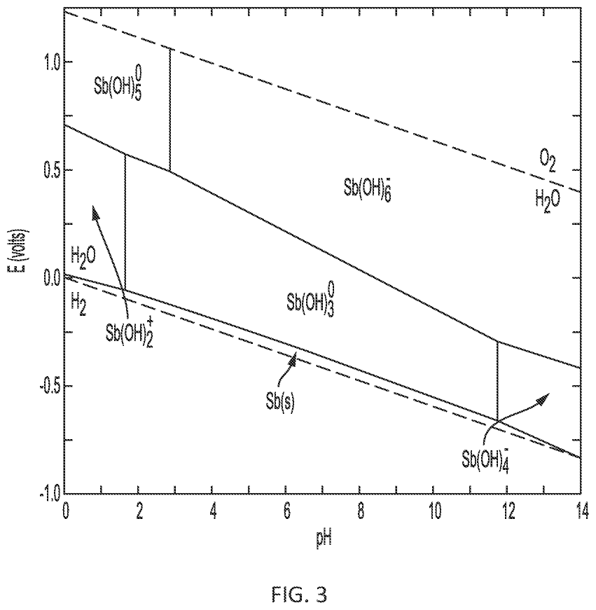

In various embodiments, antimony (Sb) and/or antimony containing compounds may be included (e.g., added, present, etc.) in an electrochemical cell, such as in the electrolyte, as part of an electrode, as a reservoir in the electrochemical cell, etc. The antimony and/or antimony containing compounds may be substituted for or combined with the tin and/or tin containing compounds discussed above and may operate in a similar manner to coat the iron anode and reduce or suspend the HER reaction to help improve the charging/recharging of the electrochemical cell. FIG. 3 is an antimony pourbaix diagram. As specific examples, antimony dialkylphosphorodithioate (SbC₁₈H₄₂O₆P₃S₆), antimony selenide (Sb₂Se₃), antimony(III) oxide (Sb₂O₃), antimony(V) oxide (Sb₂O₅), metallic antimony, antimony acetate (SbC₆H₉O₆), antimony potassium tartrate (Sb₂K₂C₈H₄O₁₂), antimony sodium tartrate (Sb₂Na₂C₈H₄O₁₂), antimony sulfate (Sb₂(SO₄)₃), antimony(III) sulfide (Sb₂S₃), potassium antimonate trihydrate (KSb₂O₃·3H₂O), or mixtures thereof, may be included in an electrochemical cell, such as in the electrolyte and/or in the electrode.

In various embodiments, the antimony (Sb) and/or antimony containing compounds may be included as part of the electrolyte in an electrochemical cell. As examples, the antimony (Sb) and/or antimony containing compounds may be added to the electrolyte in amounts such that the added antimony (Sb) and/or antimony containing compounds represent from about 0.1 millimolar (mM) to about the saturation limit of the antimony (Sb) and/or antimony containing compounds in the electrolyte. As specific examples, the antimony (Sb) and/or antimony containing compounds may be present in the electrolyte in a concentration of 0.1 mM, 0.1 mM to 10 mM, 0.1 mM to 100 mM (or 0.1 M), 10 mM, 10 mM to 100 mM (or 0.1 M), 10 mM to 50 mM, 50 mM, 50 mM to 60 mM, 10 mM to 70 mM, 10 mM to 60 mM, 50 mM to 100 mM (or 0.1 M), 50 mM to 70 mM, 60 mM to 70 mM, 60 mM, 70 mM, 70 mM to 100 mM (or 0.1M), 10 mM to 80 mM, 50 mM to 80 mM, 60 mM to 80 mM, 70 mM to 80 mM, 80 mM, 80 mM to 100 mM (or 0.1M), 100 mM (or 0.1 M), 100 mM (or 0.1 M) to 1 M, 1 M, 100 mM (or 0.1 M) to 750 mM (or 0.75 M), 750 mM (or 0.75 M), 100 mM (or 0.1 M) to 500 mM (or 0.5 M), 500 mM (or 0.5 M), 100 mM (or 0.1 M) to 600 mM (or 0.6 M), 600 mM (or 0.6 M), 100 mM (or 0.1 M) to 670 mM (or 0.67 M), 670 mM (or 0.67 M), 500 mM (or 0.5 M) to 670 mM (or 0.67 M), 600 mM (or 0.6 M) to 670 mM (or 0.67 M), 650 mM (or 0.65 M) to 670 mM (or 0.67 M), 650 mM (or 0.65 M), 0.1 mM to the saturation limit of the antimony (Sb) and/or antimony containing compounds in the electrolyte, 10 mM to the saturation limit of the antimony (Sb) and/or antimony containing compounds in the electrolyte, 50 mM to the saturation limit of the antimony (Sb) and/or antimony containing compounds in the electrolyte, 100 mM (or 0.1 M) to the saturation limit of the antimony (Sb) and/or antimony containing compounds in the electrolyte, 500 mM (or 0.5 M) to the saturation limit of the antimony (Sb) and/or antimony containing compounds in the electrolyte, 600 mM (or 0.6 M) to the saturation limit of the antimony (Sb) and/or antimony containing compounds in the electrolyte, 650 mM (or 0.65 M) to the saturation limit of the antimony (Sb) and/or antimony containing compounds in the electrolyte, 650 mM (or 0.65 M) to the saturation limit of the antimony (Sb) and/or antimony containing compounds in the electrolyte, 670 mM (or 0.67 M) to the saturation limit of the antimony (Sb) and/or antimony containing compounds in the electrolyte, 750 mM (or 0.75 M) to the saturation limit of the antimony (Sb) and/or antimony containing compounds in the electrolyte, below the saturation limit of the antimony (Sb) and/or antimony containing compounds in the electrolyte, at the saturation limit of the antimony (Sb) and/or antimony containing compounds in the electrolyte, etc. As further examples, the antimony (Sb) and/or antimony containing compounds may be added to the electrolyte in amounts such that the added antimony (Sb) and/or antimony containing compounds represent about 0.01 wt % to about 20 wt % of the electrolyte. As specific examples, the antimony (Sb) and/or antimony containing compounds may be present in the electrolyte at 0.01 wt %, 0.01 wt % to 0.1 wt %, 0.1 wt %, 0.01 wt % to 5 wt %, 0.1 wt % to 5 wt %, 0.1 wt % to 20 wt %, 5 wt %, 5 wt % to 20 wt %, 20 wt %, etc.

In various embodiments, the antimony (Sb) and/or antimony containing compounds may be included as part of the anode in an electrochemical cell. For example, the antimony (Sb) and/or antimony containing compounds may be incorporated into the anode, such as mixed with the iron source for the anode, deposited on the surface of the anode, incorporated into a bed of the anode, etc. As examples, the antimony (Sb) and/or antimony containing compounds may be added to the anode in amounts such that the added antimony and/or antimony containing compounds represent about 0.1 wt % to about 40 wt % of the anode based on the dry mass of the anode (no electrolyte included in the wt % figures). As specific examples, the antimony (Sb) and/or antimony containing compounds may be present in the anode at 0.1 wt %, 0.1 wt % to 6 wt %, 0.1 wt % to 1 wt %, about 1 wt %, about 1 wt % to about 3 wt %, about 3 wt %, about 3 wt % to about 6 wt %, about 1 wt % to about 6 wt %, about 6 wt %, 6 wt % to 20 wt %, 0.1 wt % to 5 wt %, 0.1 wt % to 0.5 wt %, about 0.5 wt %, 0.5 wt % to 5 wt %, about 5 wt %, 5 wt % to 6 wt %, 5 wt % to 7 wt %, 6 wt % to 7 wt %, about 7 wt %, about 1 wt % to about 20 wt %, 20 wt %, about 20 wt %, about 7 wt % to about 20 wt %, about 20 wt % to about 35 wt %, about 35 wt %, about 1 wt % to about 35 wt %, about 7 wt % to about 35 wt %, 35 wt %, about 1 wt % to about 40 wt %, about 7 wt % to 40 wt %, about 20 wt % to about 40 wt %, about 35 wt % to about 40 wt %, about 40 wt %, 40 wt %, etc.

In one experiment, 0.01 M antimony acetate (Sb(C₂H₃O)₂) was dissolved in a 6 M potassium hydroxide-based electrolyte to provide a source of antimony for incorporation into the anode. Specifically, after the antimony acetate was dissolved, the composition of the electrolyte was 5.95 M KOH, 0.05 M LiOH, and 0.01 M Sb(C₂H₃O)₂. The cell demonstrated increased total capacity, step 1 capacity, and increased coulombic efficiency, which leads to increased round-trip efficiency, over the entire course of cycling (50+ cycles).

In another experiment, 0.005 M antimony sodium tartrate (Na₂Sb₂(C₄H₂O₆)₂) was dissolved in a 6 M potassium hydroxide-based electrolyte to provide a source of antimony for incorporation into the anode. Specifically, after the antimony acetate was dissolved, the composition of the electrolyte was 5.95 M KOH, 0.05 M LiOH, and 0.005 M Na₂Sb₂(C₄H₂O₆)₂. The cell demonstrated increased total capacity, step 1 capacity, and increased coulombic efficiency, which leads to increased round-trip efficiency, over the entire course of cycling (50+ cycles).

In various embodiments, indium (In) and/or indium containing compounds may be included (e.g., added, present, etc.) in an electrochemical cell, such as in the electrolyte, as part of an electrode, as a reservoir in the electrochemical cell, etc. The indium and/or indium containing compounds may be substituted for or combined with the tin and/or tin containing compounds and/or the antimony and/or antimony containing compounds discussed above and may operate in a similar manner to coat the iron anode and reduce or suspend the HER reaction to help improve the charging/recharging of the electrochemical cell. As specific examples, metallic indium (In), indium (III) chloride (InCl₃), indium (III) hydroxide (In(OH)₃), indium (III) oxide (In₂O₃), indium (III) sulfate (In₂(SO₄)₃), indium (III) sulfide (In₂S₃), indium phosphide (InP), indium (III) acetate (In(C₃H₃O₂)₃), indium(III) nitrate (In(NO₃)₃), indium (III) sulfide (In₂S₃), indium (III) selenide (In₂Se₃), indium nitride (InN), indium (III) iodide (InI₃), indium (III) acetylacetonate (In(C₅H₈O₂)₃ or In(acac)₃), indium (III) fluoride (InF₃), indium arsenide (InAs), indium (III) telluride (In₂Te₃), indium (III) bromide (InBr₃), indium (I) oxide (In₂O), indium (II) oxide (InO), indium(II) selenide (InSe), indium (I) bromide (InBr), indium antimonide (InSb), or mixtures thereof may be included in an electrochemical cell, such as in the electrolyte and/or in the electrode. In various embodiments, tin sources may be solid sources or tin and/or soluble sources of tin. FIGS. 2A-2C are pourbaix diagrams of tin.

In various embodiments, the indium and/or indium containing compounds may be included as part of the electrolyte in an electrochemical cell. As examples, the indium and/or indium containing compounds may be added to the electrolyte in amounts such that the added indium and/or indium containing compounds represent from about 0.1 millimolar (mM) to about the saturation limit of the indium and/or indium containing compounds in the electrolyte. As specific examples, the indium and/or indium containing compounds may be present in the electrolyte in a concentration of 0.1 mM, 0.1 mM to 10 mM, 0.1 mM, 10 mM, 0.1 mM to 1 mM, 1 mM, 1 mM to 5 mM, 5 mM, 5 mM to 10 mM, 0.1 mM to the saturation limit of the indium and/or indium containing compounds in the electrolyte, 1 mM to the saturation limit of the indium and/or indium containing compounds in the electrolyte, 5 mM to the saturation limit of the indium and/or indium containing compounds in the electrolyte, below the saturation limit of the indium and/or indium containing compounds in the electrolyte, etc. As further examples, the indium and/or indium containing compounds may be added to the electrolyte in amounts such that the added indium and/or indium containing compounds represent about 0.01 wt % to about 20 wt % of the electrolyte. As specific examples, the indium and/or indium containing compounds may be present in the electrolyte at 0.01 wt %, 0.01 wt % to 0.1 wt %, 0.1 wt %, 0.01 wt % to 5 wt %, 0.1 wt % to 5 wt %, 0.1 wt % to 20 wt %, 5 wt %, 5 wt % to 20 wt %, 20 wt %, etc.

In various embodiments, the indium and/or indium containing compounds may be included as part of the anode in an electrochemical cell. For example, the indium and/or indium containing compounds may be incorporated into the anode, such as mixed with the iron source for the anode, deposited on the surface of the anode, incorporated into a bed of the anode, etc. As examples, the indium and/or indium containing compounds may be added to the anode in amounts such that the added indium and/or indium containing compounds represent about 0.1 wt % to about 15 wt % of the anode based on the dry mass of the anode (no electrolyte included in the wt % figures). As specific examples, the indium and/or indium containing compounds may be present in the anode at 0.1 wt %, 0.1 wt % to 6 wt %, 0.1 wt % to 1 wt %, about 1 wt %, about 1 wt % to about 3 wt %, about 3 wt %, about 3 wt % to about 6 wt %, about 1 wt % to about 6 wt %, about 6 wt %, 6 wt % to 10 wt %, 0.1 wt % to 5 wt %, 0.1 wt % to 0.5 wt %, about 0.5 wt %, 0.5 wt % to 5 wt %, about 5 wt %, 5 wt % to 6 wt %, 5 wt % to 7 wt %, 6 wt % to 7 wt %, about 7 wt %, about 1 wt % to about 15 wt %, 15 wt %, about 15 wt %, about 7 wt % to about 15 wt %, about 7 wt % to about 10 wt %, about 7 wt %, about 10 wt %, about 10 wt % to about 12 wt %, about 12 wt %, about 12 wt % to about 15 wt %, etc.

Various embodiments include using tin-bearing compound(s), antimony bearing compound(s), and/or indium bearing compounds as additive(s) to an electrolyte and/or electrode in an electrochemical system, such as a battery, having an iron-based anode. In various embodiments, the addition of stannate, antimony, and/or indium may improve total capacity, step 1 capacity, Coulombic efficiency, voltaic efficiency, and cycling of the iron-based anode. In various embodiments, the addition of stannate, antimony, and/or indium as additive(s) to an electrolyte and/or electrode in an electrochemical system, such as a battery, having an iron-based anode may result in the iron-based anode having a discharge capacity greater than 200 mAh/g, such as 200 mAh/g to 300 mAh/g, greater than 300 mAh/g, 300 mAh/g to 350 mAh/g, 350 mAh/g, 350 mAh/g to 400 mAh/g, 400 mAh/g, greater than 400 mAh/g, etc. In various embodiments, the addition of stannate, antimony, and/or indium as additive(s) to an electrolyte and/or electrode in an electrochemical system, such as a battery, having an iron-based anode may result in the iron-based anode having a discharge potential greater than 0.70V, such as 0.70V to 0.75V, 0.75V, greater than 0.75V, 0.75V to 0.8V, 0.8V, greater than 0.8V, 0.8V to 0.85V, 0.85V, greater than 0.85V, 0.85V to 0.9V, 0.9V, greater than 0.9V, etc. Various embodiments may provide an iron-based anode having a high reversibility of the step 1 reaction. Various embodiments may provide an iron-based anode having a high reversibility of the step 1 reaction in the presence of a stannate, antimony, and/or indium.

Various embodiments may include electrochemical cells including an iron anode having high hydroxide concentration electrolytes, such as hydroxide concentrations at or above about 6 M (e.g., about 6 M, 6 M, about 6 M or greater, about 6 M to about 7 M, 6 M to 7 M, about 6.5 M, 6.5 M, about 6 M to about 6.5 M, 6.5 M to about 7 M, about 7 M or greater, about 7 M to about 11 M, about 7 M to about 10 M, about 6 M to about 7.5 M, about 6.5 M to about 7.5 M, about 7 M to about 7.5 M, about 7.5 M, about 7.5 M to about 9.5 M, greater than 6 M to less than 9.5 M, greater than 6.5 M to less than 9.5 M, greater than 7M to less than 9.5 M, greater than 7.5 M to less than 9.5 M, etc.). High hydroxide concentration electrolytes may enable better step 1 reaction, i.e., Fe+2OH⁻⇄Fe(OH)₂+2e⁻. Various embodiments may include highly concentrated alkaline electrolytes including high hydroxide concentrations, such as hydroxide concentrations at or above about 6 M (e.g., about 6 M, 6 M, about 6 M or greater, about 6 M to about 7 M, 6 M to 7 M, about 6.5 M, about 6.5 M or greater, about 6 M to about 6.5 M, 6.5 M, 6 M to 6.5 M, about 6.5 M to about 7 M, 6.5 M to 7 M, about 7 M or greater, about 7 M, about 7 M to about 7.5 M, about 7.5 M, about 6 M to about 7.5 M, about 6.5 M to about 7.5 M, 7.5 M, about 7 M to about 11 M, about 7 M to about 10 M, about 7.5 M to about 9.5 M, greater than 7.5 M to less than 9.5 M, etc.), for iron electrode electrochemical cells, such as iron anode batteries. In various embodiments, hydroxides in the electrolytes may include any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂ and mixtures thereof. In various embodiments, KOH, NaOH, and LiOH are combined in ratios whereby [KOH]>[NaOH]>[LiOH]. Various embodiments may include around 4M KOH, 2M NaOH, 0.05M LiOH, or other combinations thereof. In various embodiments, KOH, NaOH, and LiOH are combined in ratios whereby [NaOH]>[KOH]>[LiOH]. Various embodiments may include around 4M NaOH, 2M KOH, 0.05M LiOH, or other combinations thereof.

Conventionally, iron-based batteries have not been operated for more than about sixteen hours, with durations of four to twelve hours being more typical. Said another way, conventionally, iron-based batteries have not been operated in a discharge mode for more than about sixteen hours, with durations of four to twelve hours being more typical for the discharge mode time periods. As such, conventionally, iron-based batteries have been tested at relatively high rates of discharge, such as 1 hour to 8 hour durations to discharge the full capacity of the conventional iron-based batteries. These shorter conventional discharge times and relatively high discharge rates for conventional testing, have left the impact of longer discharge times, such as longer than 24 hours, 24 hours to 30 hours, more than 30 hours, 30 hours to 100 hours, more than 100 hours, 100 hours to 150 hours, more than 150 hours, etc., on iron-based electrochemical cells unexplored. Specifically, the impact of high hydroxide electrolytes, such as hydroxide electrolytes having about 6 M or higher hydroxide in the electrolyte, has not been previously explored for iron-based electrochemical cells having longer discharge times, such as longer than 24 hours, 24 hours to 30 hours, more than 30 hours, 30 hours to 100 hours, more than 100 hours, 100 hours to 150 hours, more than 150 hours, etc.

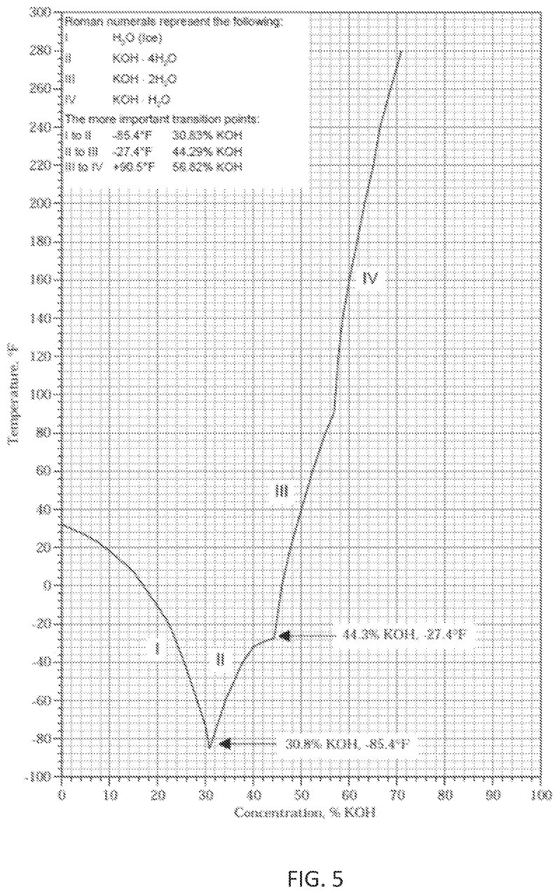

The inventors have found through experimentation that hydroxide concentrations less than about 6 M with certain anode materials result in worse performance than in higher hydroxide concentrations, such as hydroxide concentrations of about 6M, 6M, or greater than 6 M, with those certain anode materials. The inventors have specifically found a much stronger influence of the hydroxide content on performance than would be expected from prior literature when using lower purity (and thus lower cost) materials and cycling at lower rates. Thus, in the business context of long duration, ultra low cost grid scale energy storage, high hydroxide contents have a unique and unanticipated advantage for battery performance and are not only useful for increasing the stored amount of charge stored in the cell (i.e., the capacity of the battery material), but also usefully decrease the overpotential (i.e., increase the voltage) of the battery. High hydroxide concentration, such as hydroxide concentration at or above about 6 M, is unintuitive to pursue because it results in an electrolyte with lower conductivity, higher viscosity, and higher cost than lower hydroxide electrolytes. The inventors have found that at durations of longer than 24-30 hours, hydroxide contents have a very strong influence on battery capacity, with preferred hydroxide concentrations being greater than 7 M in the electrolyte. Up to about 11 M hydroxide concentrations have been tested with enhanced performance even at these very high concentrations. The upper limit of the hydroxide concentration is the solubility limit, which is displayed for KOH in FIG. 5. The solubility limit is temperature-dependent and an electrochemical cell, such as a battery, may be insulated and/or otherwise heated to achieve higher operating temperatures and thus higher hydroxide solubility. In some embodiments, surpassing the solubility limit in order to have an excess supply of solid hydroxides may be beneficial in order to preserve the highest possible concentration of hydroxide when side reactions in the electrolyte lead to a net loss in hydroxide. In various embodiments, hydroxide replenishment may also be achieved by dosing the electrolyte with hydroxide salts throughout the lifetime of the battery.

Various embodiments may include an electrochemical cell, such as a battery, having an iron negative electrode (also referred to as an iron anode) and an electrolyte having a total hydroxide concentration therein of above 7 M. In some embodiments, the electrolyte may have a total hydroxide concentration of above 7 M and up to or past a solubility limit of hydroxide in the electrolyte. In some embodiments, the electrolyte may have a total hydroxide concentration of above 7 M including greater than 6 M KOH+NaOH therein and greater than 0.05 LiOH. In some embodiments, the electrolyte may have a total hydroxide concentration of less than or equal to 11 M therein. In some embodiments, the electrolyte may have a total hydroxide concentration of less than or equal to 11 M with less than or equal to 1 M LiOH therein and less than or equal to 10 M KOH therein. In some embodiments, when the electrolyte is KOH based, the total hydroxide concentrations may be greater than 7 M and less than 10 M. In some embodiments, when the electrolyte is KOH based, the total hydroxide concentrations may be greater than 7.5 M and less than 9.5 M.

In some embodiments, sulfide may be included as an additional additive in the electrolyte with sulfide concentrations between 0.001 M and 0.5 M, typically as sodium sulfide. In some embodiments, sulfide may be included as an additional additive in the electrolyte with sulfide concentrations between 0.00001 M and 0.5 M, typically as sodium sulfide. Other salts may be used to add sulfide to the electrolyte, such as potassium sulfide. In some embodiments, no additional sulfide may be added to the electrolyte. For example, the electrolyte may have no sulfide therein. In some embodiments, sulfide may be present in other aspects of the electrochemical cell, such as in the form of additives to the anode. As one example, sulfide or a sulfide-containing compound may be an additive to the anode when the electrolyte has no sulfide therein. In various embodiments, other electrolyte additives known in the art to enhance performance or iron electrodes may also be used in the electrolyte. In various embodiments, the solvent in the electrolyte may be generally water, and preferably high purity water, such as de-ionized water.

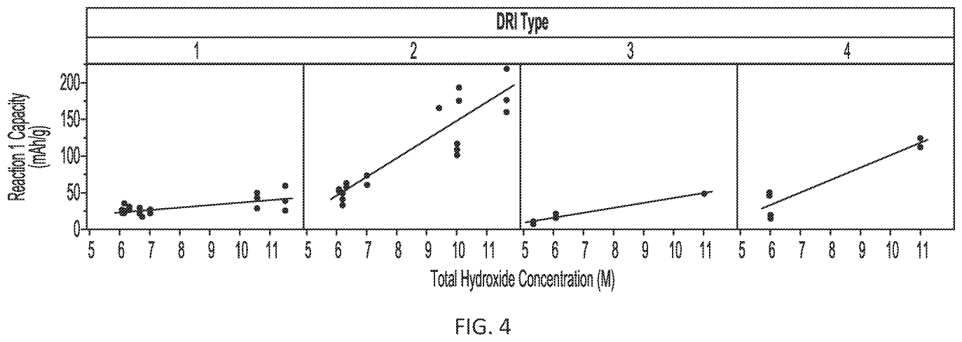

FIG. 4 shows graphs of experimental results for different DRI types using different hydroxide concentrations according to various embodiments. Through cycling with an anode half-cell at different concentrations of hydroxide electrolyte, it was found that 6 M hydroxide in the electrolyte results in worse performance than those at higher concentrations of hydroxide, such as 7 M or greater concentrations of hydroxide, across multiple different lower purity iron materials (denoted on the graph in FIG. 4 as “DRI Type”, specifically four different lower purity iron materials labeled “1”, “2”, “3”, and “4” in FIG. 4). More specifically, it was found that in increasing the electrolyte hydroxide content leads to an increase in capacity achieved via the following iron oxidation reaction, i.e., the step 1 reaction Fe+2OH⁻⇄Fe(OH)₂+2e⁻. By increasing the capacity achieved through the step 1 reaction, not only is the total energy stored in the battery increased, but the voltaic efficiency of the cell is increased, leading to an overall increase in round trip efficiency.

Various embodiments include using high hydroxide concentration electrolyte, such as a 7 molar (M) hydroxide concentration or greater, in an electrochemical system, such as a battery. In various embodiments, a high hydroxide concentration electrolyte, such as a 7 M hydroxide concentration or greater, may increase the amount of charge stored in the cell (i.e., the capacity of the battery material), improve the coulombic efficiency (i.e., increase the fraction of electrons stored in the intended charge product(s) as opposed to wasted in a side reaction), and/or decrease the overpotential (i.e., increase the voltage) of the battery.

In various embodiments, alkyl polyglucosides may be used as a co-additive with metallic HER inhibitors.

A variety of additives are used in batteries to optimize performance across various metrics, including accessible capacity and Coulombic efficiency among others. Some classes of additives that are good HER inhibitors can also be electrochemically active in the same or a similar potential window to the electrode of interest (e.g., metallic HER inhibitors or conductive additives). Since these additives can reversibly deposit on the electrode, the microstructure of the electrode evolves over time and can form dendrites or passivating films that short the cell or cause other failures.

In various embodiments, organic additives, such as the class of compounds known as alkyl polyglucosides (APGs) may be used to control the chemical or electrochemical deposition of metallic ions to prevent the formation of dendrites or engender and maintain specific architectures on the surface of an electrode. APGs are organic surfactants derived from glucose and a fatty alcohol. The alcohol functional groups of APGs may impart improved solubility in aqueous solutions. Molecules of APG are believed to adsorb at the iron surface and limit the rate of deposition of additives at the surface, encouraging the formation of even, controlled deposits on the surface. In some embodiments, organic additives including, but not limited to, APGs may be included as additional additives in the electrolyte. In some embodiments, the organic additives may be included in the electrolyte after the first charge (i.e., “dosed” into the cell). In some embodiments, the organic additives may comprise other surfactant chemistries, including, but not limited to, linear alkylbenzene sulfonates, lignin sulfonates, fatty alcohol ethoxylates, and/or alkylphenol ethoxylates.

Various embodiments may include incorporation of tin into a current collector.

Additives that slow hydrogen evolution or lower HER activity on the iron electrode may be used to improve the efficiency of iron oxide reduction. These additives may be incorporated in various ways and in different form factors to maximize interaction and effect with the electrode of interest. In various embodiments, additives that lower HER activity may be incorporated into the current collector.

Various embodiments may include incorporating tin or other metal/species into the current collector. In various embodiments, the metal/species incorporated into the current collector may be a HER inhibiting metal/species or a metal/species that lowers HER activity. In some embodiments, a metal/species including, but not limited to, tin is plated on the current collector. In some embodiments, a metal/species including, but not limited to, tin is plated on the current collector in a layer thick enough to provide an amount of tin, or other HER inhibiting species, equivalent to or less than 0.1M upon dissolution in the electrolyte. In some embodiments, a metal/species including, but not limited to, tin is coated by means of a hot tin dip on one or both sides of a current collector in contact with the anode. In some embodiments, a metal/species including, but not limited to, tin is electroplated on the current collector. In some embodiments, the current collector is stainless steel, carbon steel, or nickel. In some embodiments, a mixture of a metal/species including, but not limited to, tin and lead, are used.

Various embodiments may include tin incorporation into sponge irons.

Tin can be a performance-enhancing additive in electrochemical energy storage systems using iron negative electrodes. More homogeneous incorporation of tin-containing additives is anticipated to enhance performance of iron electrodes. Low cost iron sponge-based materials may not be produced with tin incorporated, potentially limiting the performance of these materials due to inhomogeneous incorporation. Similarly, sulfide additives have been shown to enhance the performance of iron negative electrodes, including Na₂S, FeS, SnS, SnS₂, MnS, and ZnS. Homogeneous incorporation of any solid-state additive into sponge iron precursors may be difficult, especially in a cost-effective manner.

In various embodiments, prior to reduction of the sponge iron, desired additives may be incorporated into the powder mixture that is used to produce the sponge iron. In various embodiments, the additive may be incorporated in such a manner as to assure it arrives in the final product in the desired state (as opposed to evaporating away or otherwise changing state in a way that would irreversibly lead to the additive losing function).

In some embodiments, a cassiterite ore concentrate or some other source of tin oxides, such as SnO₂, may be incorporated into an iron ore concentrate for use in making Direct Reduced Iron (DRI) such that it does not evaporate during the firing steps, and is then co-reduced with the iron oxides to yield a tin-containing sponge after the reduction process completes. In some embodiments, sodium, zinc, or manganese sulfide is added to an iron oxide powder that is reduced to form an iron oxide sponge containing sodium sulfide, zinc sulfide, or manganese sulfide. In some embodiments, materials containing multiple desired solid state additives, e.g., cylindrite (PbSn₄FeSb₂S₁₄), or a combination of materials, are incorporated into iron ore concentrate prior to reduction. In some embodiments, tin, or other desired solid state additives, are incorporated into the iron ore concentrate prior to reduction.

In various embodiments, if the solid state additive is soluble in the electrolyte, the solid state additive may be a pore former to increase the porosity of the iron electrode as well. In one example, a tin-based additive may be provided that dissolves in the electrolyte for the iron negative electrode. In such cases the additive performs multiple design roles at once.

Various embodiments may include hydrogen oxidation catalysts and/or hydrogen getters as additives to an anode of an electrochemical cell.

During the operation of an electrochemical energy storage (ESS), electrodes of the ESS participate in electrochemical reduction and oxidation reactions. Hydrogen is a possible product of a reduction reaction of an ESS from a protic electrolyte or an aqueous electrolyte produced at a negative electrode (negode). In some embodiments, evolution of hydrogen via electrolysis of an electrolyte may be desired (for example, in a flow battery where an anolyte comprises soluble hydrogenated products). However, in other embodiments, such as in a metal-air battery, the evolution of hydrogen (for example, during charging of a metal negode) may have undesirable consequences on operation and health of the ESS.

A first undesirable consequence of hydrogen evolution at a metal negode during charging may be formation of hydrogen gas bubbles. The formation of bubbles within the electrolyte may adversely impact performance of the ESS by limiting contact between the electrolyte and a surface of the negode. Limiting contact between the electrolyte and the surface of the negode may have knock-on adverse effects, such as limiting rate performance of the ESS, and causing inhomogeneities in the current distribution (hot spots) on the surface of the negode. The formation of hydrogen gas may lead to a pressure build-up, for example in an ESS that comprises a sealed compartment or a quasi-sealed compartment, the compartment further comprising a reduced-metal negode (iron negode). Further, the pressure build-up may adversely impact safety and health of the ESS by causing a leak in the compartment or being a source of fuel for an uncontrolled combustion or reduction side reaction within the ESS.

A second undesirable consequence of hydrogen evolution at a metal negode during charging may be the conversion of electrical charge into parasitic side product, which is useless for productive charging or discharging, for example decreasing the efficiency of the ESS.

Various embodiments may mitigate the adverse effects that results from the evolution of hydrogen. In some embodiments, the adverse effects that results from the evolution of hydrogen may be mitigated by inclusion of a molecular hydrogen getter, for trapping hydrogen in a soluble or quasi-soluble form. A getter may be a degasser, absorber, or scavenger. Examples of reversible getters include zirconium, magnesium-nickel alloys; AB 5 Lanthanide-Nickel alloys, graphitic materials (graphite, graphene, low-dimensional carbon materials); phenyl propargyl ether; dimerized phenyl propargyl ether. Additionally, irreversible getters may be used in various embodiments in conjunction with, or on place of, reversible getters. In various embodiments, the getter may be a surface in contact with the electrolyte. In various embodiments, the getter may be a filler material mixed into the anode composite. In various embodiments, the getter may be a molecular component of the electrolyte. The purpose of the getter may be to sequester H₂— combating the bubbles (mechanical/surface blocking effect), isolating H₂ to prevent its consumption as a fuel in a combustion reaction or side reaction and capturing the hydrogen so that it can be consumed in HOR adding to a reversible capacity of the ESS.

In some embodiments, the adverse effects that results from the evolution of hydrogen may be mitigated by inclusion of a HOR catalyst. The purpose of the catalyst may be to enable consumption of hydrogen in productive oxidation (HOR) on discharge, add to a reversible capacity of the ESS and improving Coulombic efficiency (and by extension round-trip energy efficiency of the ESS system).

Various embodiments may include lignosulfonate used as an electrolyte additive and/or an anion selective membranes.

The irreversible loss of sulfide from iron anodes over the course of cycling in an electrochemical cell or through calendar aging is one of the main causes for the loss of accessible capacity in an iron anode over time. Sulfide may be added to the anode or electrolyte of an iron-based battery to activate the anode material. Some amount of sulfide may be released on reduction of the iron during charge. After release from the iron surface, the sulfide can then migrate to the positive electrode and rapidly and irreversibly oxidize. In the absence of an applied potential, oxidation can still occur in the presence of an electrode with a sufficiently positive open circuit potential or an oxidizing agent (e.g., oxygen). This oxidation leads to the accumulation of oxidized sulfur species, such as sulfate, in the electrolyte and at the positive electrode. In certain electrolytes, the sulfate will precipitate as an alkali sulfate salt, occluding the active area of the electrodes by clogging the pores through chemisorption or physisorption or physically block blocking diffusion paths to the electrode surface through the accumulation of precipitate in the electrolyte.

In various embodiments, additives can be added to the anode or electrolyte to reduce the migration of the sulfide to the positive electrode or consume the sulfide or sulfate released from the anode. In various embodiments, additionally or alternatively, anion-selective membranes or separators can be introduced between the negative and positive electrode to impede (or further impede) migration of specific ions.

In various embodiments, lignin and its derivatives, such as lignosulfonate, may be used as additives in the electrolyte, as part of a membrane, and/or as a sulfide sink in a battery containing an iron anode. In caustic solution, lignin may react with sulfide and its oxidized byproducts to produce lignosulfonate, and may prevent the migration of sulfide to the positive electrode by reacting with the sulfide before it can reach the positive electrode. The resulting lignosulfonate may then chelate impurities in the electrolyte, preventing the potentially harmful chemicals or ions from interacting with either electrode. In various embodiments, the lignosulfonate can be incorporated into the system via electrical connection to the anode, in a permeable container adjacent to the anode, and/or in the electrolyte.

In some embodiments, lignin, lignosulfonate, or a mixture of the two may be added directly to the electrolyte solution (e.g., 5.95 M KOH, 0.05 M LiOH, 0.01 M Na₂S) before cycling, immediately prior to cycling, or during cycling in ranges between 0.1 vol % and 10 vol %. In some embodiments, lignosulfonate-type additives including, but not limited to, sodium lignosulfonate may be included as additional additives in the electrolyte with concentrations between 0.1 vol % and 10 vol %. In some embodiments, the lignosulfonate-type may be included with concentrations between 0.1 vol % and 1 vol %. In some embodiments, the lignosulfonate-type additives may be included with concentrations between 1 vol % and 10 vol %. In some embodiments, the lignosulfonate-type additives may be included in the electrolyte after some period of formation cycling (i.e., “dosed” into the cell). In some embodiments, the lignosulfonate-type additives may be included in the electrolyte after the sulfide in solution is determined to be below a certain threshold (e.g., <1.0E-3M or <1.0E-6M). In some embodiments, the lignosulfonate-type additives may comprise other chemistries, including, but not limited to, other functionalized sulfonic acids.

In some embodiments, lignin, lignosulfonate, or a mixture of the two may be added to the anode directly. In some embodiments, lignosulfonate-type additives including, but not limited to, sodium lignosulfonate may be included as additives in the anode directly. In some embodiments, the lignosulfonate-type may be included as additives in the anode directly. In some embodiments, the lignosulfonate-type additives may be included as additives in the anode. In some embodiments, the lignosulfonate-type additives may be included in the anode prior to assembly into an electrode. In some embodiments, the lignosulfonate-type additives may be incorporated on the outside of the anode after forming.

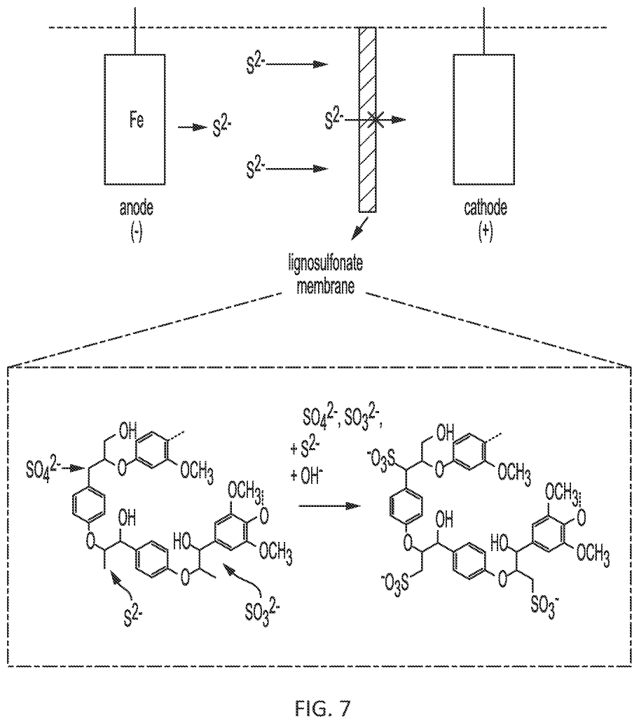

In various embodiments, lignin, lignosulfonate, or a mixture of the two may be coated on a membrane placed in an electrochemical cell. FIG. 7 illustrates aspects of an electrochemical cell including a lingosulfonate membrane in accordance with various embodiments. In some embodiments, lignin, lignosulfonate, or a mixture of the two may be coated on a membrane (e.g., cellulose, Celgard, etc.), which is then placed between the Fe negative electrode and Ni positive electrode. The cell may be then filled with an electrolyte solution containing sulfide (e.g., 5.95M KOH, 0.05M LiOH, 0.01M Na₂S) and cycled normally. In some embodiments, lignin, lignosulfonate, or a mixture of the two are coated on a membrane (e.g., cellulose, Celgard, etc.), which is then placed between the Fe negative electrode containing a sulfide source and Ni positive electrode. The cell may then be filled with an electrolyte solution without sulfide (e.g., 5.95M KOH, 0.05M LiOH) and cycled normally. In some embodiments, lignin, lignosulfonate, or a mixture of the two are coated on a membrane (e.g., cellulose, Celgard, etc.), which is then placed between the Fe negative electrode containing a sulfide source and Ni positive electrode. The cell may then be filled with an electrolyte solution containing sulfide (e.g., 5.95M KOH, 0.05M LiOH, 0.01M Na₂S) and cycled normally.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

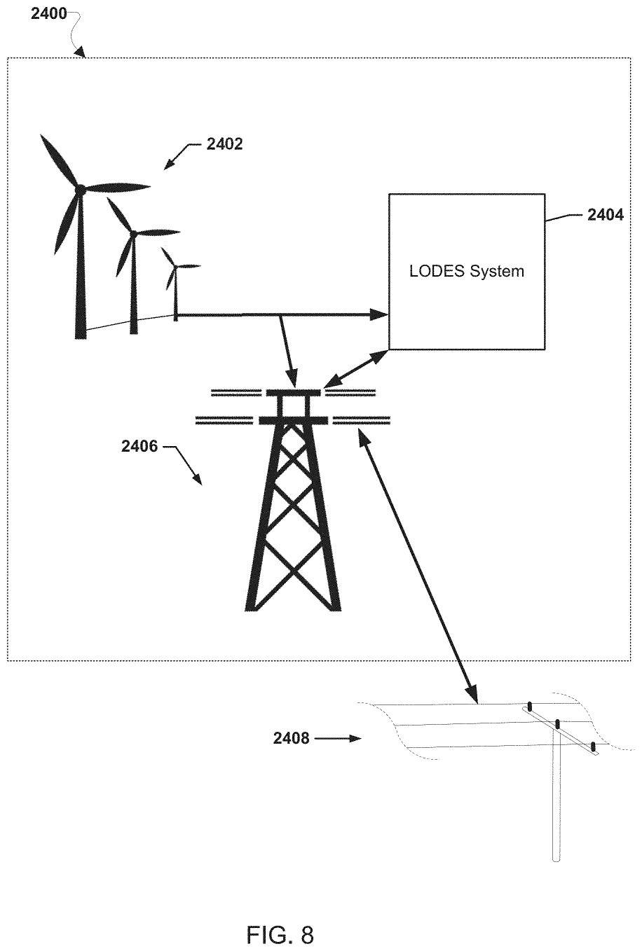

FIGS. 8-16 illustrate various example systems in which one or more aspects of the various embodiments may be used as part of bulk energy storage systems, such as LODES systems, SDES systems, etc. For example, various embodiments described herein with reference to FIGS. 1-16 may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 8 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to the grid 2408. The wind farm 2402 may generate power and the wind farm 2402 may output generated power to the LODES system 2404 and/or the transmission facilities 2406. The LODES system 2404 may store power received from the wind farm 2402 and/or the transmission facilities 2406. The LODES system 2404 may output stored power to the transmission facilities 2406. The transmission facilities 2406 may output power received from one or both of the wind farm 2402 and LODES system 2404 to the grid 2408 and/or may receive power from the grid 2408 and output that power to the LODES system 2404. Together the wind farm 2402, the LODES system 2404, and the transmission facilities 2406 may constitute a power plant 2400 that may be a combined power generation, transmission, and storage system. The power generated by the wind farm 2402 may be directly fed to the grid 2408 through the transmission facilities 2406, or may be first stored in the LODES system 2404. In certain cases, the power supplied to the grid 2408 may come entirely from the wind farm 2402, entirely from the LODES system 2404, or from a combination of the wind farm 2402 and the LODES system 2404. The dispatch of power from the combined wind farm 2402 and LODES system 2404 power plant 2400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2400, the LODES system 2404 may be used to reshape and “firm” the power produced by the wind farm 2402. In one such example, the wind farm 2402 may have a peak generation output (capacity) of 260 megawatts (MW) and a capacity factor (CF) of 41%. The LODES system 2404 may have a power rating (capacity) of 106 MW, a rated duration (energy/power ratio) of 150 hours (h), and an energy rating of 15,900 megawatt hours (MWh). In another such example, the wind farm 2402 may have a peak generation output (capacity) of 300 MW and a capacity factor (CF) of 41%. The LODES system 2404 may have a power rating of 106 MW, a rated duration (energy/power ratio) of 200 h and an energy rating of 21,200 MWh. In another such example, the wind farm 2402 may have a peak generation output (capacity) of 176 MW and a capacity factor (CF) of 53%. The LODES system 2404 may have a power rating (capacity) of 88 MW, a rated duration (energy/power ratio) of 150 h and an energy rating of 13,200 MWh. In another such example, the wind farm 2402 may have a peak generation output (capacity) of 277 MW and a capacity factor (CF) of 41%. The LODES system 2404 may have a power rating (capacity) of 97 MW, a rated duration (energy/power ratio) of 50 h and an energy rating of 4,850 MWh. In another such example, the wind farm 2402 may have a peak generation output (capacity) of 315 MW and a capacity factor (CF) of 41%. The LODES system 2404 may have a power rating (capacity) of 110 MW, a rated duration (energy/power ratio) of 25 h and an energy rating of 2,750 MWh.

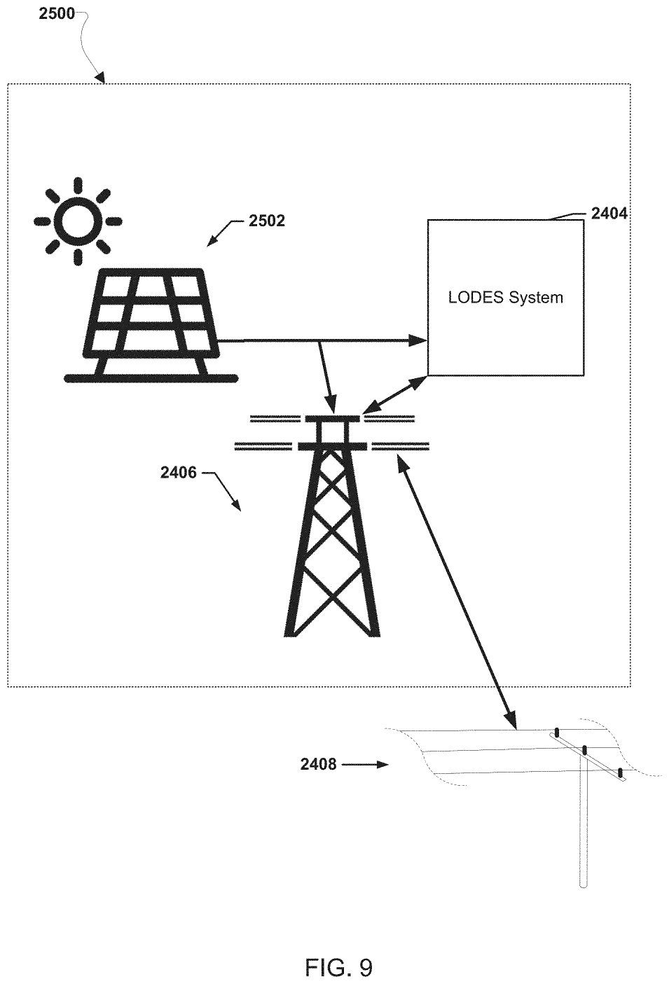

FIG. 9 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 9 may be similar to the system of FIG. 8, except a photovoltaic (PV) farm 2502 may be substituted for the wind farm 2402. The LODES system 2404 may be electrically connected to the PV farm 2502 and one or more transmission facilities 2406. The PV farm 2502 may be electrically connected to the transmission facilities 2406. The transmission facilities 2406 may be electrically connected to the grid 2408. The PV farm 2502 may generate power and the PV farm 2502 may output generated power to the LODES system 2404 and/or the transmission facilities 2406. The LODES system 2404 may store power received from the PV farm 2502 and/or the transmission facilities 2406. The LODES system 2404 may output stored power to the transmission facilities 2406. The transmission facilities 2406 may output power received from one or both of the PV farm 2502 and LODES system 2404 to the grid 2408 and/or may receive power from the grid 2408 and output that power to the LODES system 2404. Together the PV farm 2502, the LODES system 2404, and the transmission facilities 2406 may constitute a power plant 2500 that may be a combined power generation, transmission, and storage system. The power generated by the PV farm 2502 may be directly fed to the grid 2408 through the transmission facilities 2406, or may be first stored in the LODES system 2404. In certain cases, the power supplied to the grid 2408 may come entirely from the PV farm 2502, entirely from the LODES system 2404, or from a combination of the PV farm 2502 and the LODES system 2404. The dispatch of power from the combined PV farm 2502 and LODES system 2404 power plant 2500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2500, the LODES system 2404 may be used to reshape and “firm” the power produced by the PV farm 2502. In one such example, the PV farm 2502 may have a peak generation output (capacity) of 490 MW and a capacity factor (CF) of 24%. The LODES system 2404 may have a power rating (capacity) of 340 MW, a rated duration (energy/power ratio) of 150 h and an energy rating of 51,000 MWh. In another such example, the PV farm 2502 may have a peak generation output (capacity) of 680 MW and a capacity factor (CF) of 24%. The LODES system 2404 may have a power rating (capacity) of 410 MW, a rated duration (energy/power ratio) of 200 h, and an energy rating of 82,000 MWh. In another such example, the PV farm 2502 may have a peak generation output (capacity) of 330 MW and a capacity factor (CF) of 31%. The LODES system 2404 may have a power rating (capacity) of 215 MW, a rated duration (energy/power ratio) of 150 h, and an energy rating of 32,250 MWh. In another such example, the PV farm 2502 may have a peak generation output (capacity) of 510 MW and a capacity factor (CF) of 24%. The LODES system 2404 may have a power rating (capacity) of 380 MW, a rated duration (energy/power ratio) of 50 h, and an energy rating of 19,000 MWh. In another such example, the PV farm 2502 may have a peak generation output (capacity) of 630 MW and a capacity factor (CF) of 24%. The LODES system 2404 may have a power rating (capacity) of 380 MW, a rated duration (energy/power ratio) of 25 h, and an energy rating of 9,500 MWh.

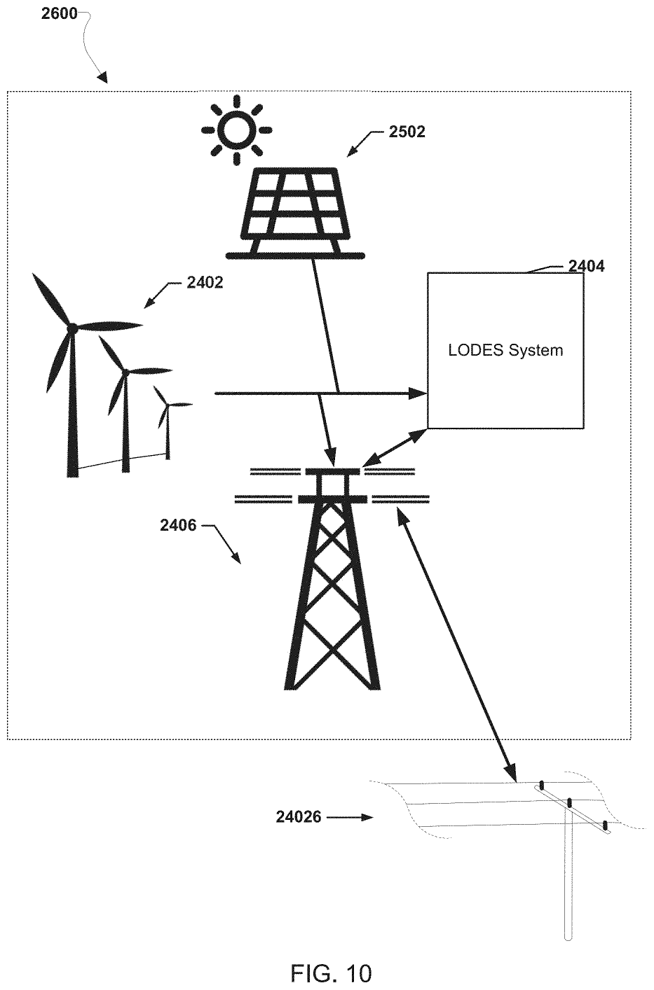

FIG. 10 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 10 may be similar to the systems of FIGS. 8 and 9, except the wind farm 2402 and the photovoltaic (PV) farm 2502 may both be power generators working together in the power plant 2600. Together the PV farm 2502, wind farm 2402, the LODES system 2404, and the transmission facilities 2406 may constitute the power plant 2600 that may be a combined power generation, transmission, and storage system. The power generated by the PV farm 2502 and/or the wind farm 2402 may be directly fed to the grid 2408 through the transmission facilities 2406, or may be first stored in the LODES system 2404. In certain cases, the power supplied to the grid 2408 may come entirely from the PV farm 2502, entirely from the wind farm 2402, entirely from the LODES system 2404, or from a combination of the PV farm 2502, the wind farm 2402, and the LODES system 2404. The dispatch of power from the combined wind farm 2402, PV farm 2502, and LODES system 2404 power plant 2600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2600, the LODES system 2404 may be used to reshape and “firm” the power produced by the wind farm 2402 and the PV farm 2502. In one such example, the wind farm 2402 may have a peak generation output (capacity) of 126 MW and a capacity factor (CF) of 41% and the PV farm 2502 may have a peak generation output (capacity) of 126 MW and a capacity factor (CF) of 24%. The LODES system 2404 may have a power rating (capacity) of 63 MW, a rated duration (energy/power ratio) of 150 h, and an energy rating of 9,450 MWh. In another such example, the wind farm 2402 may have a peak generation output (capacity) of 170 MW and a capacity factor (CF) of 41% and the PV farm 2502 may have a peak generation output (capacity) of 110 MW and a capacity factor (CF) of 24%. The LODES system 2404 may have a power rating (capacity) of 57 MW, a rated duration (energy/power ratio) of 200 h, and an energy rating of 11,400 MWh. In another such example, the wind farm 2402 may have a peak generation output (capacity) of 105 MW and a capacity factor (CF) of 51% and the PV farm 2502 may have a peak generation output (capacity) of 70 MW and a capacity factor (CF) of 31 The LODES system 2404 may have a power rating (capacity) of 61 MW, a rated duration (energy/power ratio) of 150 h, and an energy rating of 9,150 MWh. In another such example, the wind farm 2402 may have a peak generation output (capacity) of 135 MW and a capacity factor (CF) of 41% and the PV farm 2502 may have a peak generation output (capacity) of 90 MW and a capacity factor (CF) of 24%. The LODES system 2404 may have a power rating (capacity) of 68 MW, a rated duration (energy/power ratio) of 50 h, and an energy rating of 3,400 MWh. In another such example, the wind farm 2402 may have a peak generation output (capacity) of 144 MW and a capacity factor (CF) of 41% and the PV farm 2502 may have a peak generation output (capacity) of 96 MW and a capacity factor (CF) of 24%. The LODES system 2404 may have a power rating (capacity) of 72 MW, a rated duration (energy/power ratio) of 25 h, and an energy rating of 1,800 MWh.

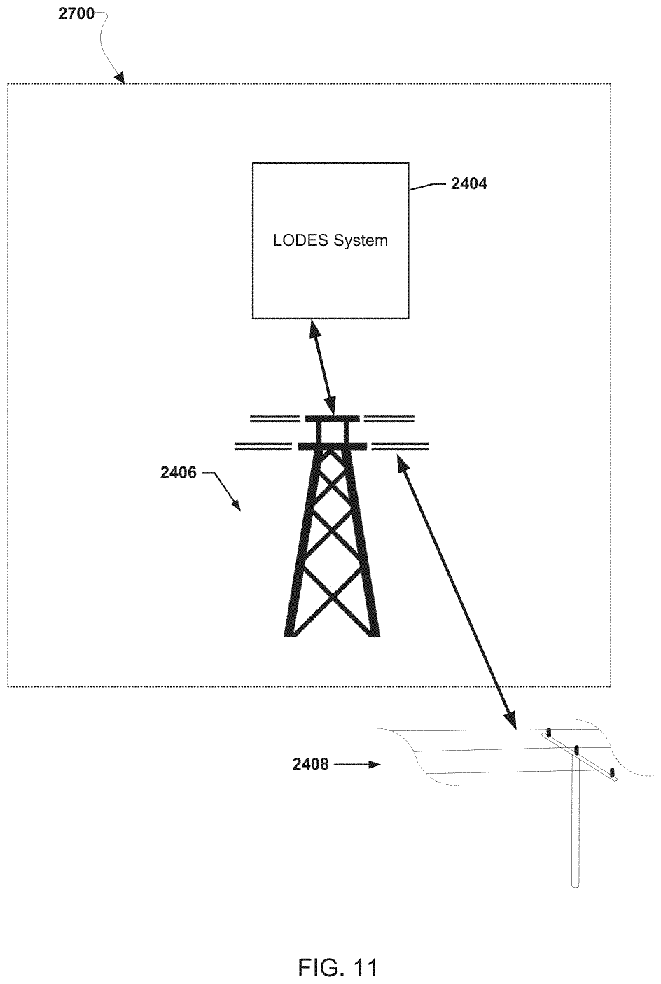

FIG. 11 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to one or more transmission facilities 2406. In this manner, the LODES system 2404 may operate in a “stand-alone” manner to arbiter energy around market prices and/or to avoid transmission constraints. The LODES system 2404 may be electrically connected to one or more transmission facilities 2406. The transmission facilities 2406 may be electrically connected to the grid 2408. The LODES system 2404 may store power received from the transmission facilities 2406. The LODES system 2404 may output stored power to the transmission facilities 2406. The transmission facilities 2406 may output power received from the LODES system 2404 to the grid 2408 and/or may receive power from the grid 2408 and output that power to the LODES system 2404.

Together the LODES system 2404 and the transmission facilities 2406 may constitute a power plant 900. As an example, the power plant 900 may be situated downstream of a transmission constraint, close to electrical consumption. In such an example downstream situated power plant 2700, the LODES system 2404 may have a duration of 24 h to 500 h and may undergo one or more full discharges a year to support peak electrical consumptions at times when the transmission capacity is not sufficient to serve customers. Additionally in such an example downstream situated power plant 2700, the LODES system 2404 may undergo several shallow discharges (daily or at higher frequency) to arbiter the difference between nighttime and daytime electricity prices and reduce the overall cost of electrical service to customer. As a further example, the power plant 2700 may be situated upstream of a transmission constraint, close to electrical generation. In such an example upstream situated power plant 2700, the LODES system 2404 may have a duration of 24 h to 500 h and may undergo one or more full charges a year to absorb excess generation at times when the transmission capacity is not sufficient to distribute the electricity to customers. Additionally in such an example upstream situated power plant 2700, the LODES system 2404 may undergo several shallow charges and discharges (daily or at higher frequency) to arbiter the difference between nighttime and daytime electricity prices and maximize the value of the output of the generation facilities.

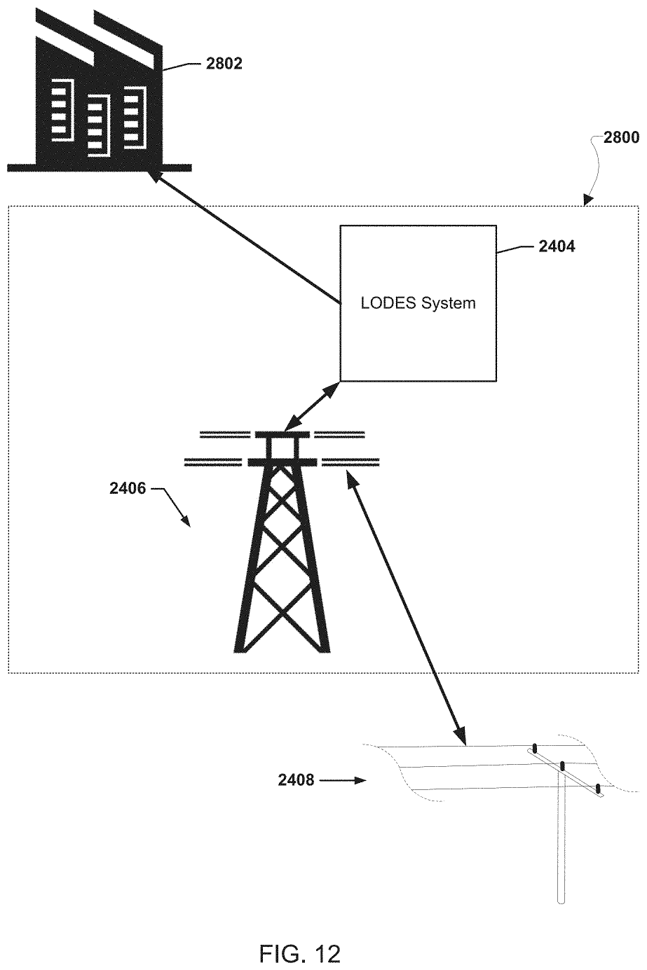

FIG. 12 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a commercial and industrial (C&I) customer 2802, such as a data center, factory, etc. The LODES system 2404 may be electrically connected to one or more transmission facilities 2406. The transmission facilities 2406 may be electrically connected to the grid 2408. The transmission facilities 2406 may receive power from the grid 2408 and output that power to the LODES system 2404. The LODES system 2404 may store power received from the transmission facilities 2406. The LODES system 2404 may output stored power to the C&I customer 2802. In this manner, the LODES system 2404 may operate to reshape electricity purchased from the grid 2408 to match the consumption pattern of the C&I customer 2802.

Together, the LODES system 2404 and transmission facilities 2406 may constitute a power plant 2800. As an example, the power plant 2800 may be situated close to electrical consumption, i.e., close to the C&I customer 2802, such as between the grid 2408 and the C&I customer 2802. In such an example, the LODES system 2404 may have a duration of 24 h to 500 h and may buy electricity from the markets and thereby charge the LODES system 2404 at times when the electricity is cheaper. The LODES system 2404 may then discharge to provide the C&I customer 2802 with electricity at times when the market price is expensive, therefore offsetting the market purchases of the C&I customer 2802. As an alternative configuration, rather than being situated between the grid 2408 and the C&I customer 2802, the power plant 2800 may be situated between a renewable source, such as a PV farm, wind farm, etc., and the transmission facilities 2406 may connect to the renewable source. In such an alternative example, the LODES system 2404 may have a duration of 24 h to 500 h, and the LODES system 2404 may charge at times when renewable output may be available. The LODES system 2404 may then discharge to provide the C&I customer 2802 with renewable generated electricity so as to cover a portion, or the entirety, of the C&I customer 2802 electricity needs.

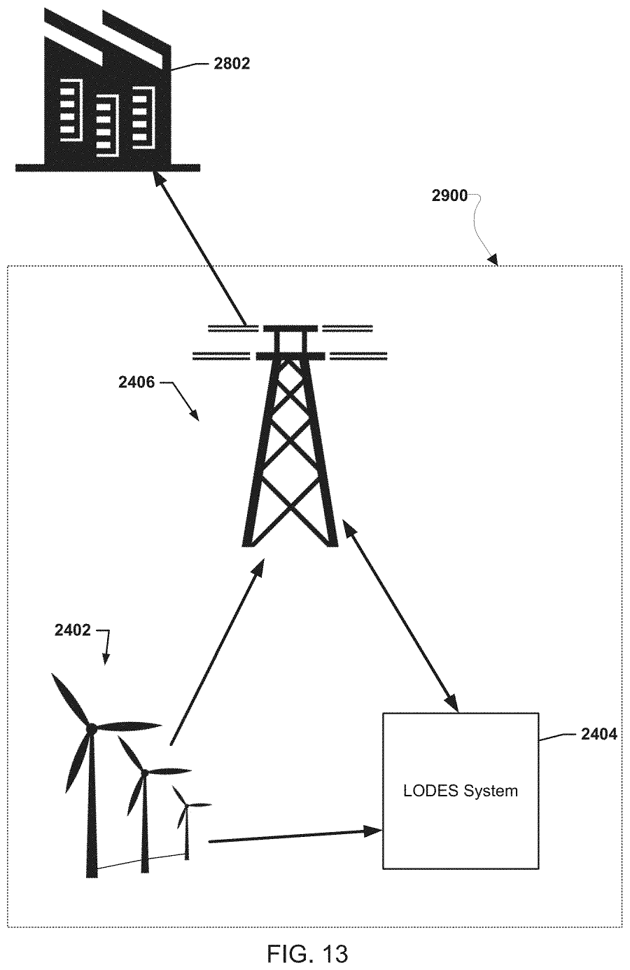

FIG. 13 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to a C&I customer 2802. The wind farm 2402 may generate power and the wind farm 2402 may output generated power to the LODES system 2404 and/or the transmission facilities 2406. The LODES system 2404 may store power received from the wind farm 2402.

The LODES system 2404 may output stored power to the transmission facilities 2406. The transmission facilities 2406 may output power received from one or both of the wind farm 2402 and LODES system 2404 to the C&I customer 2802. Together the wind farm 2402, the LODES system 2404, and the transmission facilities 2406 may constitute a power plant 2900 that may be a combined power generation, transmission, and storage system. The power generated by the wind farm 2402 may be directly fed to the C&I customer 2802 through the transmission facilities 2406, or may be first stored in the LODES system 2404. In certain cases, the power supplied to the C&I customer 2802 may come entirely from the wind farm 2402, entirely from the LODES system 2404, or from a combination of the wind farm 2402 and the LODES system 2404. The LODES system 2404 may be used to reshape the electricity generated by the wind farm 2402 to match the consumption pattern of the C&I customer 2802. In one such example, the LODES system 2404 may have a duration of 24 h to 500 h and may charge when renewable generation by the wind farm 2402 exceeds the C&I customer 2802 load. The LODES system 2404 may then discharge when renewable generation by the wind farm 2402 falls short of C&I customer 2802 load so as to provide the C&I customer 2802 with a firm renewable profile that offsets a fraction, or all of, the C&I customer 2802 electrical consumption.

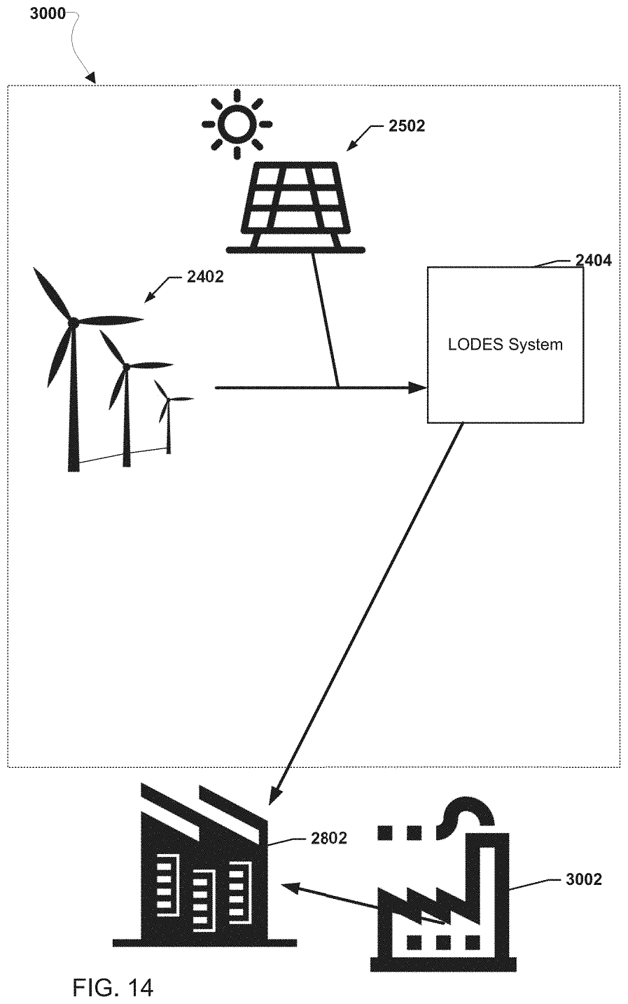

FIG. 14 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be part of a power plant 3000 that is used to integrate large amounts of renewable generation in microgrids and harmonize the output of renewable generation by, for example a PV farm 2502 and wind farm 2402, with existing thermal generation by, for example a thermal power plant 3002 (e.g., a gas plant, a coal plant, a diesel generator set, etc., or a combination of thermal generation methods), while renewable generation and thermal generation supply the C&I customer 2802 load at high availability. Microgrids, such as the microgrid constituted by the power plant 3000 and the thermal power plant 3002, may provide availability that is 90% or higher. The power generated by the PV farm 2502 and/or the wind farm 2402 may be directly fed to the C&I customer 2802, or may be first stored in the LODES system 2404.

In certain cases, the power supplied to the C&I customer 2802 may come entirely from the PV farm 2502, entirely from the wind farm 2402, entirely from the LODES system 2404, entirely from the thermal power plant 3002, or from any combination of the PV farm 2502, the wind farm 2402, the LODES system 2404, and/or the thermal power plant 3002. As examples, the LODES system 2404 of the power plant 3000 may have a duration of 24 h to 500 h. As a specific example, the C&I customer 2802 load may have a peak of 100 MW, the LODES system 2404 may have a power rating of 14 MW and duration of 150 h, natural gas may cost $6/million British thermal units (MMBTU), and the renewable penetration may be 58%. As another specific example, the C&I customer 2802 load may have a peak of 100 MW, the LODES system 2404 may have a power rating of 25 MW and duration of 150 h, natural gas may cost $8/MMBTU, and the renewable penetration may be 65%.

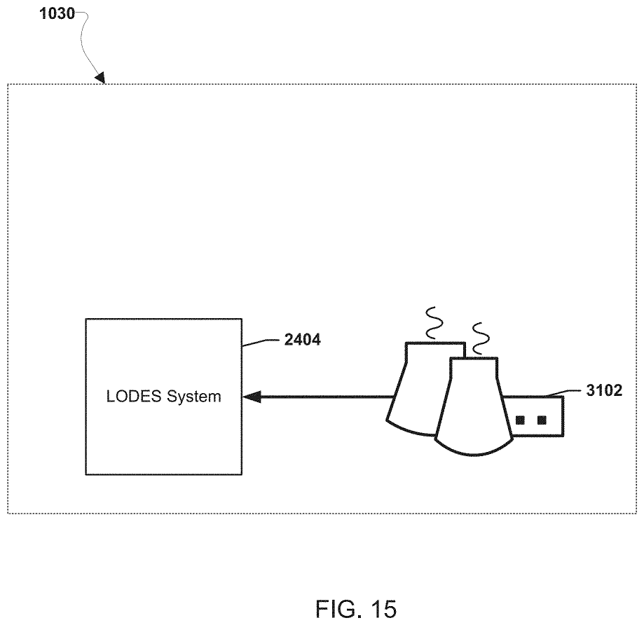

FIG. 15 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be used to augment a nuclear plant 3102 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 3100 constituted by the combined LODES system 2404 and nuclear plant 3102. The nuclear plant 3102 may operate at high capacity factor and at the highest efficiency point, while the LODES system 2404 may charge and discharge to effectively reshape the output of the nuclear plant 3102 to match a customer electrical consumption and/or a market price of electricity. As examples, the LODES system 2404 of the power plant 3100 may have a duration of 24 h to 500 h. In one specific example, the nuclear plant 3102 may have 1,000 MW of rated output and the nuclear plant 3102 may be forced into prolonged periods of minimum stable generation or even shutdowns because of depressed market pricing of electricity. The LODES system 2404 may avoid facility shutdowns and charge at times of depressed market pricing; and the LODES system 2404 may subsequently discharge and boost total output generation at times of inflated market pricing.

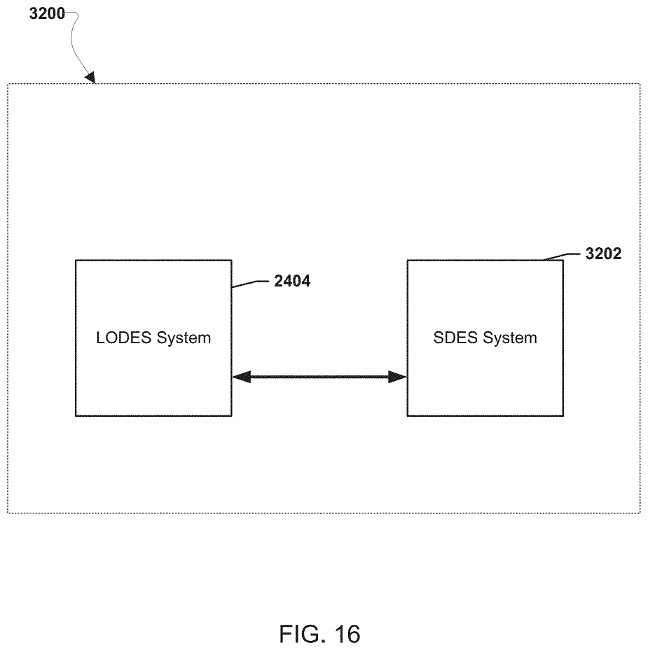

FIG. 16 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may operate in tandem with a SDES system 3202. Together the LODES system 2404 and SDES system 3202 may constitute a power plant 3200. As an example, the LODES system 2404 and SDES system 3202 may be co-optimized whereby the LODES system 2404 may provide various services, including long-duration back-up and/or bridging through multi-day fluctuations (e.g., multi-day fluctuations in market pricing, renewable generation, electrical consumption, etc.), and the SDES system 3202 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 3202 may have durations of less than 10 hours and round-trip efficiencies of greater than 80%. The LODES system 2404 may have durations of 24 h to 500 h and round-trip efficiencies of greater than 40%. In one such example, the LODES system 2404 may have a duration of 150 hours and support customer electrical consumption for up to a week of renewable under-generation. The LODES system 2404 may also support customer electrical consumption during intra-day under-generation events, augmenting the capabilities of the SDES system 3202. Further, the SDES system 3202 may supply customers during intra-day under-generation events and provide power conditioning and quality services such as voltage control and frequency regulation.

Various examples of aspects of the various embodiments are described in the following paragraphs.

Example 1. A battery, comprising: a first electrode, comprising iron; an electrolyte; and a second electrode, wherein the first electrode or the electrolyte includes an additive. Example 2. The battery of example 1, wherein the additive contains an element that has a low hydrogen evolution reaction (HER) activity and/or improves charging of the first electrode. Example 3. The battery of any of examples 1-2, wherein the iron comprises direct reduced iron (DRI) and/or another sponge iron powder. Example 4. The battery of any of examples 1-3, wherein the element comprises tin and/or antimony. Example 5. The battery of example 4, wherein the additive comprises sodium stannate trihydrate (Na₂SnO₃·3H₂O), metallic tin, potassium stannate trihydrate (K₂SnO₃·3H₂O), tin oxide (SnO₂), cylindrite (Pb₃Sn₄FeSb₂S₁₄), copper iron tin sulfide (Cu₂FeSnS₄), lead-tin alloys (60/40 Sn/Pb solder, 63/37 Sn/Pb solder, Terne I alloy: 10-20% Sn, balance Pb), zinc-tin alloys (Terne II alloy: 10-20% Sn, balance Zn), or tin sulfide (SnS or SnS₂). Example 6. The battery of any of examples 1-5, wherein the additive is in the electrolyte in a concentration of 0.1 mM or greater. Example 7. The battery of example 6, wherein the additive is in the electrolyte in a concentration of about 10 mM. Example 8. The battery of example 6, wherein the additive is in the electrolyte in a concentration of about 100 mM. Example 9. The battery of example 6, wherein the additive is in the electrolyte in a concentration of about 10 mM to about 100 mM. Example 10. The battery of example 6, wherein the additive is in the electrolyte in a concentration of about 650 mM, or wherein the additive is in the electrolyte in a concentration of about 50 mM. Example 11. The battery of example 6, wherein the additive is in the electrolyte in a concentration of about 670 mM. Example 12. The battery of example 6, wherein the additive is in the electrolyte in a concentration of about 750 mM. Example 13. The battery of example 6, wherein the additive is in the electrolyte at or below a saturation limit. Example 14. The battery of any of examples 1-5, wherein the additive is in the first electrode in an amount from about 0.1 wt % of the first electrode to about 20 wt % of the first electrode. Example 15. The battery of example 14, wherein the additive is in the first electrode in an amount of about 1 wt %. Example 16. The battery of example 14, wherein the additive is in the first electrode in an amount of about 6 wt %. Example 17. The battery of example 14, wherein the additive is in the first electrode in an amount of about 1 wt % to 10 wt %. Example 18. The battery of any of examples 1-17, wherein the electrolyte comprises lithium hydroxide (LiOH), potassium hydroxide (KOH) and/or sodium hydroxide (NaOH), and optionally sodium sulfide (Na₂S). Example 19. The battery of any of examples 1-18, wherein the additive is plated on the second electrode. Example 20. The battery of any of examples 1-19, wherein the additive is disposed in a reservoir suspended in the electrolyte. Example 21. The battery of any of examples 1-3 and 18-20, wherein the additive comprises antimony. Example 22. The battery of any of examples 1-21, wherein the electrolyte comprises one or more hydroxide and a total hydroxide concentration in the electrolyte is about 6M or greater. Example 23. The battery of any of examples 1-21, wherein the electrolyte comprises one or more hydroxide and a total hydroxide concentration in the electrolyte is greater than 7 M. Example 24. The battery of example 23, wherein the total hydroxide concentration in the electrolyte is greater than 7 M and less than or equal to 11 M. Example 25. The battery of example 24, wherein the electrolyte includes greater than 6 M of combined KOH and NaOH and greater than or equal to 0.05 M of LiOH. Example 26. The battery of example 24, wherein the electrolyte includes greater a concentration of KOH, NaOH, and LiOH such that a molar concentration of KOH is greater than a molar concentration of NaOH and the molar concentration of NaOH is greater than a molar concentration of LiOH. Example 27. The battery of example 23, wherein the total hydroxide concentration in the electrolyte is greater than 7 M and less than 10 M. Example 28. The battery of example 23, wherein the total hydroxide concentration in the electrolyte is greater than 7.5 M and less than 9.5 M. Example 29. The battery of any of examples 27-28, wherein the electrolyte includes KOH. Example 30. The battery of any of examples 22-29, wherein the electrolyte includes at least 0.05 M of LiOH. Example 31. The battery of any of examples 22-30, wherein the electrolyte includes any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂ and mixtures thereof. Example 32. The battery of any of examples 22-31, wherein the electrolyte includes a sulfide. Example 33. The battery of example 32, wherein the sulfide concentration in the electrolyte is between 0.001 M and 0.5 M. Example 34. The battery of any of examples 21-30, wherein the electrolyte does not include a sulfide. Example 35. The battery of any of examples 1-34, wherein the additive is at least partially a solid. Example 36. The battery of example 35, wherein a surface area of the solid is selected to provide a level of reactivity such that there is a constant flux of additive into the liquid electrolyte phase and/or to maintain the additive concentration in the liquid electrolyte phase at or above a selected concentration.

Example 37. A battery, comprising: a first electrode, comprising iron; an electrolyte; and a second electrode, wherein the electrolyte comprises one or more hydroxide.

Example 38. The battery of example 37, wherein the iron is direct reduced iron (DRI) or another sponge iron powder.

Example 39. A battery, comprising: a first electrode, comprising direct reduced iron (DRI) or another sponge iron powder; an electrolyte comprising an hydroxide; and a second electrode, wherein the first electrode or the electrolyte further comprises an additive, said additive comprising at least one of tin, lead, or antimony.

Example 40. The battery of any of examples 37-39, wherein a total hydroxide concentration in the electrolyte is about 6 M or greater. Example 41. The battery of any of examples 37-39, wherein a total hydroxide concentration in the electrolyte is greater than 7 M. Example 42. The battery of example 41, wherein the total hydroxide concentration in the electrolyte is greater than 7 M and less than or equal to 11 M. Example 43. The battery of example 42, wherein the electrolyte includes greater than 6 M of combined KOH and NaOH and greater than or equal to 0.05 M of LiOH. Example 44. The battery of example 42, wherein the electrolyte includes greater a concentration of KOH, NaOH, and LiOH such that a molar concentration of KOH is greater than a molar concentration of NaOH and the molar concentration of NaOH is greater than a molar concentration of LiOH. Example 45. The battery any of examples 37-39, wherein the total hydroxide concentration in the electrolyte is greater than 7 M and less than 10 M. Example 46. The battery of any of examples 37-39, wherein the total hydroxide concentration in the electrolyte is greater than 7.5 M and less than 9.5 M. Example 47. The battery of any of examples 45-46, wherein the electrolyte includes KOH. Example 48. The battery of any of examples 37-47, wherein the electrolyte includes at least 0.05 M of LiOH. Example 49. The battery of any of examples 37-48, wherein the electrolyte includes any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂ and mixtures thereof. Example 50. The battery of any of examples 37-49, wherein the electrolyte includes a sulfide. Example 51. The battery of example 50, wherein the sulfide concentration in the electrolyte is between 0.001 M and 0.5 M. Example 52. The battery of any of examples 37-49, wherein the electrolyte does not include a sulfide.

Example 53. A bulk energy storage system, comprising: a stack of one or more batteries, wherein at least one of the one or more batteries comprises a battery of any of examples 1-52. Example 54. The bulk energy storage system of example 53, wherein the bulk energy storage system is a long duration energy storage (LODES) system. Example 55. The bulk energy storage system of example 54, wherein the LODES system is configured to discharge for a period greater than 24 hours. Example 56. The bulk energy storage system of example 55, wherein the LODES system is configured to discharge for a period greater than 30 hours. Example 57. The bulk energy storage system of example 55, wherein the LODES system is configured to discharge for a period greater than 100 hours. Example 58. The bulk energy storage system of example 55, wherein the LODES system is configured to discharge for a period greater than 150 hours.

Example 59. A method of operating a battery having an iron-based electrode, comprising: adding an additive of any of examples 1-36 to the battery; and/or adding a hydroxide according to any of examples 37-52 to the battery. Example 60. The method of example 59, wherein the iron-based electrode comprises DRI or another sponge iron powder. Example 61. The method of example 59, further comprising adding one or more organic additives to an electrolyte of the battery. Example 62. The method of example 61, wherein the one or more organic additives comprise one or more alkyl polyglucosides. Example 63. The method of any of examples 59-62, further comprising incorporating tin into a current collector of the battery. Example 64. The method of any of examples 59-62, further comprising, prior to reduction of sponge iron, incorporating selected additives into a powder mixture that is used to produce the sponge iron. Example 65. The method of any of examples 59-64, further comprising adding a HOR catalyst to the battery. Example 66. The method of any of examples 59-65, further comprising trapping hydrogen in a soluble or quasi-soluble form. Example 67. The method of any of examples 59-66, further comprising: adding additives to the anode and/or electrolyte to reduce migration of sulfide to the positive electrode or consume the sulfide or sulfate released from the anode; and/or adding anion-selective membranes or separators to impede migration of specific ions. Example 68. The method of example 67, wherein the additives and/or anion-selective membranes or separators comprise lignin and its derivatives, such as lignosulfonate.

Example 69. A method comprising adding one or more organic additives to an electrolyte of a battery. Example 70. The method of example 69, wherein the one or more organic additives comprise one or more alkyl polyglucosides.

Example 71. A method comprising incorporating tin into a current collector of a battery.

Example 72. A method comprising, prior to reduction of sponge iron, incorporating selected additives into a powder mixture that is used to produce the sponge iron and forming an electrode of the battery from the produced sponge iron.

Example 73. A method comprising adding a HOR catalyst to the battery.

Example 74. A method comprising trapping hydrogen in a soluble or quasi-soluble form.

Example 75. A method comprising: adding additives to an anode and/or electrolyte of a battery to reduce migration of sulfide to a positive electrode or consume the sulfide or sulfate released from the anode; and/or adding anion-selective membranes or separators to the battery to impede migration of specific ions. Example 76. The method of example 75, wherein the additives and/or anion-selective membranes or separators comprise lignin and its derivatives, such as lignosulfonate.

Example 77. A battery of any of examples 1-52 and/or a bulk energy storage system of any of examples 53-58, wherein the electrolyte includes one or more organic additives. Example 78. The battery and/or bulk energy storage system of example 77, wherein the one or more organic additives comprise one or more alkyl polyglucosides.

Example 79. A battery of any of examples 1-52, 77, and 78 and/or a bulk energy storage system of any of examples 53-58, 77, and 78, further comprising a current collector having incorporated tin therein.

Example 80. A battery of any of examples 1-52, and 77-79 and/or a bulk energy storage system of any of examples 53-58 and 77-79, wherein the DRI or another sponge iron powder comprises selected additives that were incorporated into a powder mixture that was used to produce the DRI or another sponge iron powder.

Example 81. A battery of any of examples 1-52, and 77-80 and/or a bulk energy storage system of any of examples 53-58 and 77-80, further comprising a HOR catalyst and/or a hydrogen getter.

Example 82. A battery of any of examples 1-52, and 77-81 and/or a bulk energy storage system of any of examples 53-58 and 77-81, further comprising: additives in the first electrode and/or electrolyte to reduce migration of sulfide to the second electrode or consume the sulfide or sulfate released from the first electrode; and/or an anion-selective membrane or separator to impede migration of specific ions. Example 83. The battery and/or bulk energy storage system of example 82, wherein the additives and/or anion-selective membrane or separator comprise lignin and its derivatives, such as lignosulfonate.

Example 84. A battery and/or bulk energy storage system, wherein the electrolyte includes one or more organic additives. Example 85. The battery and/or bulk energy storage system of example 84, wherein the one or more organic additives comprise one or more alkyl polyglucosides.

Example 86. A battery and/or bulk energy storage system wherein a current collector has incorporated tin therein.

Example 87. A battery and/or bulk energy storage system, having an electrode comprising DRI or another sponge iron powder comprising selected additives that were incorporated into a powder mixture that was used to produce the DRI or another sponge iron powder.

Example 88. A battery and/or bulk energy storage system comprising a HOR catalyst and/or a hydrogen getter.

Example 89. A battery and/or bulk energy storage system comprising: additives in a first electrode and/or an electrolyte to reduce migration of sulfide to a second electrode or consume the sulfide or sulfate released from the first electrode; and/or an anion-selective membrane or separator to impede migration of specific ions. Example 90. The battery and/or bulk energy storage system of example 89, wherein the additives and/or anion-selective membrane or separator comprise lignin and its derivatives, such as lignosulfonate.

Example 1A. A battery, comprising: a first electrode, comprising direct reduced iron (DRI) or another sponge iron powder; an electrolyte; and a second electrode, wherein the first electrode or the electrolyte includes an additive containing an element that has a low hydrogen evolution reaction (HER) activity and/or improves a characteristic of the battery. Example 2A. The battery of example 1A, wherein improving a characteristic of the battery comprises one or more of: improving charging of the first electrode; improving a conditioning process of the first electrode; improving reversibility of a half-cell reaction of the first electrode; improving discharge capacity of the first electrode. Example 3A. The battery of any of examples 1A or 2A, wherein the element comprises tin, antimony, and/or indium. Example 4A. The battery of example 3A, wherein the additive comprises sodium stannate trihydrate (Na₂SnO₃·3H₂O), metallic tin, potassium stannate trihydrate (K₂SnO₃·3H₂O), tin oxide (SnO₂), cylindrite (Pb₃Sn₄FeSb₂S₁₄), copper iron tin sulfide (Cu₂FeSnS₄), lead-tin alloys (60/40 Sn/Pb solder, 63/37 Sn/Pb solder, Terne I alloy: 10-20% Sn, balance Pb), zinc-tin alloys (Terne II alloy: 10-20% Sn, balance Zn), iron tin oxide (FeSnO₃), tin sulfide (SnS or SnS₂), or mixtures thereof. Example 5A. The battery of example 3A, wherein the additive comprises antimony dialkylphosphorodithioate (SbC₁₈H₄₂O₆P₃S₆), antimony selenide (Sb₂Se₃), antimony(III) oxide (Sb₂O₃), antimony(V) oxide (Sb₂O₅), metallic antimony, antimony acetate (SbC₆H₉O₆), antimony potassium tartrate (Sb₂K₂C₈H₄O₁₂), antimony sodium tartrate (Sb₂Na₂C₈H₄O₁₂), antimony sulfate (Sb₂(SO₄)₃), antimony(III) sulfide (Sb₂S₃), potassium antimonate trihydrate (KSb₂O₃·3H₂O), or mixtures thereof. Example 6A. The battery of example 3A, wherein the additive comprises metallic indium (In), indium (III) chloride (InCl₃), indium (III) hydroxide (In(OH)₃), indium (III) oxide (In₂O₃), indium (III) sulfate (In₂(SO₄)₃), indium (III) sulfide (In₂S₃), indium phosphide (InP), indium (III) acetate (In(C₃H₃O₂)₃), indium(III) nitrate (In(NO₃)₃), indium (III) sulfide (In₂S₃), indium (III) selenide (In₂Se₃), indium nitride (InN), indium (III) iodide (InI₃), indium (III) acetylacetonate (In(C₅H₈O₂)₃ or In(acac)₃), indium (III) fluoride (InF₃), indium arsenide (InAs), indium (III) telluride (In₂Te₃), indium (III) bromide (InBr₃), indium (I) oxide (In₂O), indium (II) oxide (InO), indium(II) selenide (InSe), indium (I) bromide (InBr), indium antimonide (InSb), or mixtures thereof. Example 7A. The battery of any of examples 1A-6A, wherein the additive is in the electrolyte in a concentration of 0.1 mM or greater. Example 8A. The battery of example 7A, wherein the additive is in the electrolyte in a concentration of about 0.1 mM to about 10 mM. Example 9A. The battery of example 7A, wherein the additive is in the electrolyte in a concentration of about 10 mM to about 100 mM. Example 10A. The battery of any of examples 1A-6A, wherein the additive is in the first electrode in an amount from about 0.1 wt % of the first electrode to about 40 wt % of the first electrode. Example 11A. The battery of example 10A, wherein the additive is in the first electrode in an amount from about 10 wt % to about 35 wt %. Example 12A. The battery of example 10A, wherein the additive is in the first electrode in an amount from about 15 wt % to about 20 wt %. Example 13A. The battery of any of examples 1A-12A, wherein the electrolyte comprises potassium hydroxide (KOH) and/or sodium hydroxide (NaOH), and optionally sodium sulfide (Na₂S) and lithium hydroxide (LiOH). Example 14A. The battery of any of examples 1A-13A, wherein the additive is plated on the second electrode, electrodeposited on the second electrode, or disposed in a reservoir suspended in the electrolyte. Example 15A. The battery of any of examples 1A-14A, wherein the electrolyte includes a sulfide. Example 16A. The battery of example 15A, wherein the sulfide concentration in the electrolyte is between 0.00001 M and 0.5 M. Example 17A. The battery of any of examples 1A-14A, wherein the electrolyte does not include a sulfide. Example 18A. The battery of any of examples 1A-17A, wherein the additive is at least partially a solid. Example 19A. The battery of example 18, wherein a surface area of the solid is selected to provide a level of reactivity such that there is a constant flux of additive into the liquid electrolyte phase and/or to maintain the additive concentration in the liquid electrolyte phase at or above a selected concentration. Example 20A. A battery, comprising: a first electrode, comprising direct reduced iron (DRI) or another sponge iron powder; an electrolyte comprising a hydroxide; and a second electrode, wherein the first electrode or the electrolyte further comprises an additive, said additive comprising at least one of tin, lead, indium, or antimony. Example 21A. The battery of example 20A, wherein a total hydroxide concentration in the electrolyte is about 6 M or greater. Example 22A. The battery of example 21A, wherein a total hydroxide concentration in the electrolyte is about 6.5 M or greater. Example 23A. The battery of example 22A, wherein the total hydroxide concentration in the electrolyte is greater than about 7 M or greater. Example 24A. The battery of example 23A, wherein the total hydroxide concentration in the electrolyte is greater than about 7.5 M or greater. Example 25A. The battery of any of examples 21A-24A wherein the electrolyte includes KOH. Example 26A. The battery of any of examples 21A-25A, wherein the electrolyte includes at least 0.05 M of LiOH. Example 27A. The battery of any of examples 21A-24A, wherein the electrolyte includes any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂, and mixtures thereof. Example 28A. The battery of any of examples 21A-27A, wherein the electrolyte includes a sulfide. Example 29A. The battery of example 28A, wherein the sulfide concentration in the electrolyte is between 0.00001 M and 0.5 M. Example 30A. The battery of any of examples 21A-27A, wherein the electrolyte does not include a sulfide. Example 31. The battery of any of examples 1-30, wherein the first electrode has a discharge capacity greater than 300 mAh/g, such as greater than 350 mAh/g or greater than 400 mAh/g. Example 32. The battery of any of examples 1-30, wherein the first electrode has a discharge potential of greater than 0.75V, such as greater than 0.8V, greater than 0.85V, greater than 0.9V, etc. Example 33A. A bulk energy storage system, comprising: a stack of one or more batteries, wherein at least one of the one or more batteries comprises a battery of any of examples 1A-32A. Example 34A. The bulk energy storage system of example 34A, wherein the bulk energy storage system is a long duration energy storage (LODES) system.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

1. A battery, comprising:
a first electrode, comprising direct reduced iron (DRI) or another sponge iron powder;
an electrolyte; and
a second electrode,
wherein the first electrode or the electrolyte includes an additive containing an element that has a low hydrogen evolution reaction (HER) activity and/or improves a characteristic of the battery.

2. The battery of claim 1, wherein improving a characteristic of the battery comprises one or more of:
improving charging of the first electrode;
improving a conditioning process of the first electrode;
improving reversibility of a half-cell reaction of the first electrode; and
improving discharge capacity of the first electrode.

3. The battery of claim 1, wherein the element comprises tin, antimony, and/or indium.

4. The battery of claim 3, wherein the additive comprises sodium stannate trihydrate (Na₂SnO₃·3H₂O), metallic tin, potassium stannate trihydrate (K₂SnO₃·3H₂O), tin oxide (SnO₂), cylindrite (Pb₃Sn₄FeSb₂S₁₄), copper iron tin sulfide (Cu₂FeSnS₄), lead-tin alloys, zinc-tin alloys, or mixtures thereof.

5. The battery of claim 3, wherein the additive comprises antimony dialkylphosphorodithioate (SbC₁₈H₄₂O₆P₃S₆), antimony selenide (Sb₂Se₃), antimony(III) oxide (Sb₂O₃), antimony(V) oxide (Sb₂O₅), metallic antimony, antimony acetate (SbC₆H₉O₆), antimony potassium tartrate (Sb₂K₂C₈H₄O₁₂), antimony sodium tartrate (Sb₂Na₂C₈H₄O₁₂), antimony sulfate (Sb₂(SO₄)₃), antimony(III) sulfide (Sb₂S₃), potassium antimonate trihydrate (KSb₂O₃·3H₂O), or mixtures thereof.

6. The battery of claim 3, wherein the additive comprises metallic indium (In), indium (III) chloride (InCl₃), indium (III) hydroxide (In(OH)₃), indium (III) oxide (In₂O₃), indium (III) sulfate (In₂(SO₄)₃), indium (III) sulfide (In₂S₃), indium phosphide (InP), indium (III) acetate (In(C₃H₃O₂)₃), indium(III) nitrate (In(NO₃)₃), indium (III) sulfide (In₂S₃), indium (III) selenide (In₂Se₃), indium nitride (InN), indium (III) iodide (InI₃), indium (III) acetylacetonate (In(C₅H₈O₂)₃ or In(acac)₃), indium (III) fluoride (InF₃), indium arsenide (InAs), indium (III) telluride (In₂Te₃), indium (III) bromide (InBr₃), indium (I) oxide (In₂O), indium (II) oxide (InO), indium(II) selenide (InSe), indium (I) bromide (InBr), indium antimonide (InSb), or mixtures thereof.

7-9. (canceled)

10. The battery of claim 1, wherein the additive is in the first electrode in an amount from about 0.1 wt % of the first electrode to about 40 wt % of the first electrode.

11-12. (canceled)

13. The battery of claim 1, wherein the electrolyte comprises potassium hydroxide (KOH) and/or sodium hydroxide (NaOH), and optionally sodium sulfide (Na₂S) and lithium hydroxide (LiOH).

14. The battery of claim 1, wherein the additive is plated on the second electrode, electrodeposited on the second electrode, or disposed in a reservoir suspended in the electrolyte.

15. The battery of claim 1, wherein the electrolyte includes a sulfide.

16-17. (canceled)

18. The battery of claim 1, wherein the additive is at least partially a solid.

19. The battery of claim 18, wherein a surface area of the solid is selected to provide a level of reactivity such that there is a constant flux of the additive into a liquid electrolyte phase and/or to maintain concentration of the additive in the liquid electrolyte phase at or above a selected concentration.

20. A battery, comprising:
a first electrode, comprising direct reduced iron (DRI) or another sponge iron powder;
an electrolyte comprising a hydroxide; and
a second electrode,
wherein the first electrode or the electrolyte further comprises an additive, said additive comprising at least one of tin, lead, indium, or antimony.

21-22. (canceled)

23. The battery of claim 20, wherein total concentration of the hydroxide in the electrolyte is greater than about 7 M or greater.

24. (canceled)

25. The battery of claim 20, wherein the electrolyte includes KOH.

26. The battery of claim 20, wherein the electrolyte includes at least 0.05 M of LiOH.

27. The battery of claim 20, wherein the electrolyte includes any one or more of KOH, NaOH, LiOH, RbOH, CsOH, FrOH, Be(OH)₂, Ca(OH)₂, Mg(OH)₂, Sr(OH)₂, Ra(OH)₂, Ba(OH)₂, and mixtures thereof.

28. The battery of claim 20, wherein the electrolyte includes a sulfide.

29-30. (canceled)

31. The battery of claim 1, wherein the first electrode has a discharge capacity greater than 300 mAh/g.

32. The battery of claim 1, wherein the first electrode has a discharge potential of greater than 0.75V.

33-34. (canceled)
